(19) United States
(12) Patent Application Publication
(10) Pub. No.: US 2024/0371539 A1
(43) Pub. Date: Nov. 7, 2024

(54) COMPOSITE CONFINEMENT APPARATUS ASSEMBLY INCLUDING PHOTONICS PLATFORM

(71) Applicant: Quantinuum LLC, Broomfield, CO (US)

(72) Inventors: Adam Jay Ollanik, Boulder, CO (US); Mary A. Rowe, Boulder, CO (US); Molly R. Krogstad, Westminster, CO (US); Bryan DeBono, Broomfield, CO (US); Matthew J. Bohn, Broomfield, CO (US); Curtis Volin, Marietta, GA (US); Matthew Blain, Broomfield, CO (US); Todd Michael Klein, Wayzata, MN (US); Christopher T. Ertsgaard, Champlin, MN (US); John Pagnucci Gaebler, Broomfield, CO (US); Rezlind Bushati, Broomfield, CO (US); David M. Gaudiosi, Broomfield, CO (US)

(21) Appl. No.: 18/479,588

(22) Filed: Oct. 2, 2023

Related U.S. Application Data
(60) Provisional application No. 63/511,956, filed on Jul. 5, 2023.
(60) Provisional application No. 63/378,124, filed on Oct. 3, 2022.

(51) Int. Cl. G21K 1/00; G02B 6/12; G02B 6/136; G06N 10/20; G06N 10/40; G21K 1/10

(52) U.S. Cl. CPC G21K 1/003; G02B 6/136; G06N 10/20; G06N 10/40; G21K 1/10; G02B 2006/12157

(57) ABSTRACT

A composite confinement apparatus assembly is provided. The composite confinement apparatus assembly includes a quantum object confinement apparatus and a photonic platform. The confinement apparatus includes one or more electrical components and is fabricated on a confinement apparatus substrate. The photonic platform includes one or more photonic components that are hosted by a photonic platform substrate. The photonic platform substrate is mechanically coupled to the confinement apparatus substrate to form the composite confinement apparatus assembly.

### CROSS-REFERENCE TO RELATED APPLICATIONS

This application claims priority to U.S. Application No. 63/378,124, filed Oct. 3, 2022, and U.S. Application No. 63/511,956, filed Jul. 5, 2023, the contents of which are incorporated herein by reference in their entireties.

### TECHNICAL FIELD

Various embodiments relate to composite confinement apparatus assemblies that include photonics platforms, system including composite confinement apparatus assemblies, and methods of manufacturing composite confinement apparatus assemblies. An example embodiment relates to a composite confinement apparatus assembly comprising a confinement apparatus formed on a confinement apparatus substrate and a photonics platform secured thereto. An example embodiment relates to a quantum charge-coupled device (QCCD)-based quantum computer that includes a composite confinement apparatus assembly.

### BACKGROUND

When using an ion trap to perform quantum computing, gates and other functions of the quantum computer are performed by applying laser beams to ions contained within the ion trap. Delivering these laser beams to a large scale quantum computer is a significant challenge due to the low ion height above the trap, the Rayleigh range of the laser beams, and the amount of laser power that needs to be delivered to an ion within the trap to perform the functions of the quantum computer. Through applied effort, ingenuity, and innovation many deficiencies of prior laser beam application techniques have been solved by developing solutions that are structured in accordance with the embodiments of the present invention, many examples of which are described in detail herein.

### BRIEF SUMMARY OF EXAMPLE EMBODIMENTS

Example embodiments provide composite confinement apparatus assemblies, assemblies or systems comprising composite confinement apparatus assemblies, and methods for fabricating composite confinement apparatus assemblies. In various embodiments, a composite confinement apparatus assembly includes a confinement apparatus formed on a confinement apparatus substrate and a photonics platform that is secured in relation to the confinement apparatus. For example, the photonics platform is secured to the confinement apparatus substrate via spacing structures (e.g., legs, a nano-positioner mounting system, and/or the like), in various embodiments. An example embodiment provides a QCCD-based quantum processor that includes a composite confinement apparatus assembly.

According to an aspect of the present disclosure, a composite confinement apparatus assembly is provided. In an example embodiment, the composite confinement includes a quantum object confinement apparatus comprising one or more electrical components. The quantum object confinement apparatus is fabricated on a confinement apparatus substrate. The composite confinement apparatus further includes a photonic platform comprising one or more photonic components hosted by a photonic platform substrate. The photonic platform substrate is mechanically coupled to the confinement apparatus substrate to form the composite confinement apparatus assembly.

In an example embodiment, the photonic platform comprises a conductive layer confinement apparatus substrate on a surface of the photonic platform substrate facing the quantum object confinement apparatus, wherein the conductive layer is configured to be held at a fixed electric potential and comprises a transparent section of the conductive layer.

In an example embodiment, a surface of the conductive layer facing the quantum object confinement apparatus has an anti-reflecting property.

In an example embodiment, the photonic platform comprises an anti-reflective layer on a surface of the photonic platform substrate facing away from the quantum object confinement apparatus.

In an example embodiment, the photonic platform comprises one or more photonic platform sink components configured to act as a respective optical sink configured to enable and/or facilitate removal of one or more undesired photons from a space between the quantum object confinement apparatus and the photonic platform for reducing an undesired illumination of one or more untargeted quantum objects located between the quantum object confinement apparatus and the photonic platform.

In an example embodiment, the one or more sink components comprise one or more of a hole in the photonic platform configured to pass at least a first portion of the one or more undesired photons through the photonic platform substrate, an engineered coating with high optical transmittance configured to transmit at least a second portion of the one or more undesired photons therethrough, and a photon absorber configured to absorb at least a third portion of the one or more undesired photons.

In an example embodiment, the one or more photonic components of the photonic platform include one or more flat optics elements; one or more guided mode photonic elements; one or more microfabricated lenses; or one or more claddings.

In an example embodiment, the quantum object confinement apparatus comprises a confinement apparatus photon sink configured to enable and/or facilitate removal of one or more undesired photons from a space between the quantum object confinement apparatus and the photonic platform for reducing an undesired illumination of one or more untargeted quantum objects located in the space between the quantum object confinement apparatus and the photonic platform, wherein the confinement apparatus photon sink comprises one or more of a hole or a transparent window in the confinement apparatus substrate configured to pass at least a first portion of the one or more undesired photons through the confinement apparatus substrate, and a photon absorber configured to absorb at least a second portion of the one or more undesired photons.

In an example embodiment, the hole or transparent window in the photonic platform substrate configured to pass at least the first portion of the one or more undesired photons through the confinement apparatus substrate is further configured to dissipate at least the first portion of the one or more undesired photons.

In an example embodiment, the hole in the quantum object confinement apparatus comprises a sink photon absorber configured to absorb at least the first portion of the one or more undesired photons in the hole in the confinement apparatus substrate.

In an example embodiment, an optical component is formed on the confinement apparatus substrate, the optical component configured to be illuminated by a first optical beam or pulse train and provide a second optical beam or pulse train toward a defined location, wherein the defined location is defined at least in part by the confinement apparatus.

In an example embodiment, the photonic platform is configured to at least one of (a) provide the first optical beam or pulse train to the optical component or (b) provide a third optical beam or pulse train to the defined location, wherein the third optical beam or pulse train is co-axial to the second optical beam or pulse train.

In an example embodiment, the photonic platform substrate is mechanically coupled to the confinement apparatus substrate via one or more spacing structures.

In an example embodiment, each of the one or more spacing structures has a thickness corresponding to a set distance between the photonic platform and the confinement apparatus substrate.

In an example embodiment, at least one of the one or more spacing structures comprises respective actuators configured to mechanically couple the photonic platform to the confinement apparatus substrate in an adjustable manner.

In an example embodiment, the respective actuators comprise a piezoelectric actuator.

In an example embodiment, the photonic platform substrate is mechanically coupled to the confinement apparatus substrate via a nano-positioner mounting apparatus.

According to another aspect, a method for fabricating a composite confinement apparatus assembly is provided. In an example embodiment, the method comprises fabricating a photonic platform comprising one or more photonic components hosted by a photonic platform substrate, the photonic platform substrate having one or more spacing structures extending from a confinement apparatus-facing surface of the photonic platform; and coupling the one or more spacing structures to a confinement apparatus substrate, the confinement apparatus substrate having a quantum object confinement apparatus comprising one or more electrical components formed thereon.

In an example embodiment, the method further includes bonding a spacer wafer to the photonic platform substrate; and etching the spacer wafer to form the one or more spacing structures.

In an example embodiment, the photonic platform substrate comprises a transparent material.

In an example embodiment, the photonic platform substrate comprises silicon dioxide, silicon nitride, aluminum oxide, aluminum nitride, tantalum pentoxide, hafnia, or silicon carbide, and the spacer wafer comprises silicon, silicon dioxide, silicon nitride, aluminum oxide, aluminum nitride, tantalum pentoxide, hafnia, or silicon carbide.

In an example embodiment, fabricating the photonic platform comprises fabricating one or more photonic components on and/or in the photonic platform substrate.

In an example embodiment, the one or more photonic components comprise one or more flat optics elements; one or more guided mode photonic elements; one or more microfabricated lenses; one or more claddings; one or more photonic filters; one or more photonic convertors; one or more photonic detectors; or one or more active optical elements.

In an example embodiment, fabricating the photonic platform comprises fabricating one or more first photonic components on a surface of the photonic platform substrate configured to face away from the confinement apparatus; fabricating a cladding layer on the one or more first photonic components; smoothing a surface of the cladding layer; and fabricating one or more second photonic components on the smoothed cladding.

In an example embodiment, an anti-reflection coating is applied to the surface of the smoothed cladding.

In an example embodiment, the cladding layer and the photonic platform substrate comprise a common transparent material.

In an example embodiment, fabricating the photonic platform comprises fabricating a conductive layer on a surface of the photonic platform substrate configured to face the confinement apparatus.

In an example embodiment, the wherein a surface of the conductive layer configured to face the quantum object confinement apparatus has an anti-reflective property.

In an example embodiment, relative positions of the one or more spacing structures are defined using lithography.

In an example embodiment, the method further comprises patterning one or more alignment marks on each of the one or more spacing structures; and patterning corresponding alignment marks to each of one or more bond locations on the confinement apparatus substrate; wherein coupling the one or more spacing structures to a confinement apparatus substrate comprises aligning the one or more alignment marks with the corresponding alignment marks and bonding the one or more spacing structures to the bond locations on the confinement apparatus substrate.

In an example embodiment, the one or more spacing structures comprise respective actuators configured to adjust a relative positioning of the photonic platform and the confinement apparatus with respect to each other.

In an example embodiment, the respective actuators comprise respective piezoelectric actuators.

According to another aspect, a quantum processor is provided. In an example embodiment, the quantum processor includes a cryogenic and/or vacuum chamber; and a composite confinement apparatus assembly disposed within the cryogenic and/or vacuum chamber.

According to another aspect, a quantum computer is provided. In an example embodiment, the quantum computer includes a quantum processor including a composite confinement apparatus assembly and a controller configured to control at least one of voltage sources configured to provide voltage signal to the electrical components of the quantum object confinement apparatus or operation of a photonic component of the photonic platform that comprises an active optical element.

According to another aspect, a composite confinement apparatus assembly is provided. The composite confinement apparatus assembly includes a quantum object confinement apparatus fabricated on a confinement apparatus substrate; and a photonic platform comprising: one or more photonic components hosted by a photonic platform substrate; and a loading opening configured to pass quantum objects to the quantum object confinement apparatus.

In an example embodiment, the photonic platform substrate is mechanically coupled to the confinement apparatus substrate to form the composite confinement apparatus assembly, and the quantum objects are generated by a source outside the composite confinement apparatus assembly.

In an example embodiment, the loading opening comprises a through hole through the photonic platform.

In an example embodiment, the photonic platform comprises one or more photonic layers and the loading opening passes through all the photonic layers.

In an example embodiment, the composite confinement apparatus assembly comprises a confinement apparatus volume created by mechanically coupling the photonic platform substrate with the confinement apparatus substrate.

In an example embodiment, the composite confinement apparatus assembly comprises a particle flux opening configured to pass quantum objects not captured and/or confined by the confinement apparatus to exit the confinement apparatus volume.

In an example embodiment, the particle flux opening comprises a through hole through the photonic platform.

In an example embodiment, the particle flux opening is parallel with the loading opening.

In an example embodiment, the particle flux opening comprises a through hole through the confinement apparatus.

In an example embodiment, the particle flux opening is co-linear with the loading opening.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a schematic diagram illustrating an example quantum computing system comprising an composite confinement apparatus assembly, according to an example embodiment.

FIG. 2 is a schematic cross section view of a portion of a composite confinement apparatus assembly, according to an example embodiment.

FIGS. 3A and 3B are respective schematic cross-section views a composite confinement apparatus assembly including optical sinks, according to example embodiments.

FIG. 4 is a schematic cross-section view of a composite confinement apparatus assembly including a collection optical path, according to an example embodiment.

FIGS. 5A-5E are schematic cross-section views illustrating some example cavities formed at least in part using surface photonic components, according to an example embodiment.

FIG. 6 is a flowchart illustrating processes, procedures, and/or operations for fabricating a composite confinement apparatus assembly, according to an example embodiment.

FIGS. 7A-7F are schematic cross-section views showing various points in the fabrication of a composite confinement apparatus assembly, according to an example embodiment.

FIG. 8 provides a schematic diagram of an example controller of a quantum computer configured to control operation of various components of a quantum processor, according to various embodiments.

FIG. 9 provides a schematic diagram of an example computing entity of a quantum computer system that may be used in accordance with an example embodiment.

### DETAILED DESCRIPTION OF SOME EXAMPLE EMBODIMENTS

The present invention now will be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. The term “or” (also denoted “/”) is used herein in both the alternative and conjunctive sense, unless otherwise indicated. The terms “illustrative” and “exemplary” are used to be examples with no indication of quality level. The terms “generally,” “substantially,” and “approximately” refer to within engineering and/or manufacturing tolerances and/or within user measurement capabilities, unless otherwise indicated. Like numbers refer to like elements throughout.

Example embodiments provide apparatuses, systems, and corresponding methods for composite confinement apparatus assemblies, various systems comprising at least one composite confinement apparatus assembly, including quantum processors (e.g., QCCD-based quantum processors) and/or quantum computers comprising at least one composite confinement apparatus assembly. Various embodiments provide fabrication methods for fabricating a composite confinement apparatus assembly.

In various embodiments, a composite confinement apparatus assembly includes a confinement apparatus and at least a portion of a signal management system. For example, in various embodiments, a composite confinement apparatus assembly comprises a confinement apparatus substrate having a confinement apparatus formed thereon. For example, electrical components that form and/or define the confinement apparatus are disposed and/or formed on the confinement apparatus substrate. The electrical components include electrodes configured for defining confinement regions within which quantum objects may be confined. The composite confinement apparatus assembly further comprises a photonics platform. In various embodiments, the photonics platform is part of signal management system configured to control and/or provide photonic beams and/or pulses provided to one or more object locations. The object locations are defined, at least in part, by the confinement apparatus. For example, the photonics platform includes optical components that may be used to control and/or provide photonic beams and/or pulses provided to the one or more object locations. The photonics platform is coupled and/or secured to the confinement apparatus substrate via spacing structures (e.g., legs, spacers, nano-positioner mounting systems, and/or the like).

In various embodiments, the confinement apparatus is configured to confine a plurality of quantum objects at respective object locations defined at least in part by the confinement apparatus. The confinement apparatus is further configured to transport respective quantum objects between respective object locations. The signal management system is configured to provide select manipulation signals (e.g., laser beams, laser pulses, microwave beams or pulses, and/or the like) to particular object locations.

In an example embodiment, the confinement apparatus substrate further includes one or more optical components that are disposed and/or formed thereon and/or therein. In various embodiments, the one or more optical components are configured to provide respective manipulation signals to respective object locations defined within the confinement regions of the confinement apparatus and/or to receive/detect respective optical signals emitted by respective quantum objects located at respective object locations. For example, the one or more optical components disposed and/or formed on the confinement apparatus substrate are part of the signal manipulation system. In various embodiments, the one or more optical components include passive and/or active optical elements. In an example embodiment, active optical elements include photodetectors such as photodiode, photomultiplier, charge-coupled device (CCD) sensor, complementary metal oxide semiconductor (CMOS) sensor, Micro-Electro-Mechanical Systems (MEMS) sensor, modulator, and/or other photodetector.

In various embodiments, the confinement apparatus chip defines a plurality and/or an array of object locations. For example, the confinement apparatus chip may be configured such that when appropriate voltage signals are applied to electrical components (e.g., electrodes) thereof, an electric potential is generated that is configured to confine quantum objects at respective object locations. In various embodiments, a sub-array of object locations may be configured for performing a particular function (e.g., a reading function, performance of a single qubit or multi-qubit (e.g., two qubit) gate, and/or the like. In various embodiments, the optical components disposed on the confinement apparatus substrate, and/or photonic components disposed on the photonic platform that are configured for performance of the particular function are arrayed on their respective substrates accordingly.

In various embodiments, the confinement apparatus is an ion trap, such as a surface ion trap, Paul ion trap, and/or the like. Various other embodiments may include various other confinement apparatuses (e.g., optical trap and/or the like). In various embodiments, the quantum objects are neutral or ionic atoms; neutral, ionic, or multipole molecules; quantum particles; quantum dots; and/or other objects configured to be confined by the confinement apparatus and having quantum states that can be manipulated and/or controlled.

In various embodiments, the signal management system is configured to generate, provide, control parameters of (e.g., wavelength, intensity, phase, polarization, and/or the like) of electromagnetic signals applied to one or more object locations defined at least in part by the confinement apparatus for the purpose of controlling the quantum state of one or more quantum objects confined by the confinement apparatus. In various embodiments, the signal management system comprises photonic components that are part of the photonic platform. The signal management system may also include one or more optical components formed on the confinement apparatus substrate, in various embodiments. The photonic components and/or optical components may include active and/or passive optical elements respectively configured for generating, providing, collecting/detecting, and/or controlling parameters of manipulation signals applied to various object locations and/or collected from various object locations defined by the confinement apparatus. In an example embodiment, active optical elements includes photodetectors such as photodiode, photomultiplier, charge-coupled device (CCD) sensor, complementary metal oxide semiconductor (CMOS) sensor, Micro-Electro-Mechanical Systems (MEMS) sensor, modulator, and/or other photodetector. In various embodiments, the photonic components and/or optical components of the signal management system comprise flat optics (e.g., metasurfaces, diffractive optical elements, waveguides, tapers, routing components, grating couplers, ring resonators, etc.), guided mode photonics (e.g., waveguides, tapers, routing components, grating couplers, ring resonators, modulators, etc.), photonic filters, photonic convertors, microfabricated lenses, and/or the like. For example, in various embodiments, the photonic components and/or optical components of the signal management system comprise one or more diffractive optical elements (DOEs), passive metasurfaces, active metasurfaces, optical modulators, low loss waveguides, amplifiers, on-chip lasers, photodetectors, grating couplers, beam splitters, edge couplers, optical local oscillators, tapers, reference cavities, optical sinks, light absorbing structures, anti-reflection coatings, optical routing elements, resonant structures, and/or the like. In various embodiments, various photonic components and/or optical components of the signal management system have electrical components associated therewith (e.g., the optical elements may be active optical elements with electrically controlled aspects) and other photonic components and/or optical components of the signal management system do not have electrical components associated therewith (e.g., the optical elements may be passive optical elements and/or active elements controlled via a technique other than electric signal-based control).

In various embodiments, the confinement apparatus and/or confinement apparatus substrate define an apparatus plane. In various embodiments, the photonic platform defines a platform plane. In various embodiments, the platform plane is parallel to the apparatus plane but not coplanar with the apparatus plane. For example, the platform plane and the apparatus plane are separated by a set distance. A confinement apparatus volume is defined between the confinement apparatus substrate and the photonic platform. The confinement regions generated through the operation of the electrical components of the confinement apparatus (which are formed on the confinement apparatus substrate) generate confinement regions that are disposed within the confinement apparatus volume defined between the confinement apparatus and the photonic platform. For example, the object locations defined at least in part by the confinement apparatus are within the confinement apparatus volume defined between the confinement apparatus and the photonic platform.

In various embodiments, the composite confinement apparatus assembly is disposed within the action region of a cryogenic and/or vacuum chamber and configured to be operated under cryogenic and/or ultra-high vacuum conditions. For example, the composite confinement apparatus assembly is configured to be operated at temperatures at or less than 124 K and/or pressures at or less than 10⁻⁶ Pa.

In various embodiments, a composite confinement apparatus assembly is part of a QCCD-based quantum system comprising a confinement apparatus configured for confining quantum objects and a signal management system. In various embodiments, the signal management system includes the photonic platform and may include one or more optical components disposed on the confinement apparatus substrate. In various embodiments, respective composite confinement apparatus assemblies are part of various quantum and/or atomic systems (e.g., atomic clocks, quantum clocks, and/or other systems that include confined quantum objects).

Conventionally, laser beams are provided to positions within an ion trap through the use of external lasers and free space optics configured to provide the laser beams to specific positions within the ion trap. However, the amount of space required for such beam paths, even to provide laser beams to a relatively small number of defined positions of the ion trap, is significant (e.g., a few square meters). Additionally, the accuracy with which the laser beams may be provided to the positions within the ion trap through such conventional means can limit the density of the defined positions of ion trap. Moreover, ion traps are generally utilized within a cryogenic and/or vacuum chamber. As such, the laser beams must be passed through the cryogenic and/or vacuum chamber and any radiation and/or thermal shields therein. Thus, a technical problem exists as to how to provide manipulation signals to a quantum object confinement apparatus that is able to scale with the size and/or dimensions of the quantum object confinement apparatus efficiently and accurately. These technical problems are compounded as the quantum object confinement apparatus is increased in size (e.g., as the number of positions or object locations defined for the quantum object confinement apparatus increases).

Various embodiments provide technical solutions to these technical problems. In particular, in various embodiments, optical elements of the signal management system are incorporated and/or integrated into a composite confinement apparatus assembly. For example, one or more optical elements of the signal management system are disposed within the cryogenic and/or vacuum chamber. For example, the one or more optical elements of the signal management system include photonic components that are part of a photonic platform that is coupled and/or secured into relation with the confinement apparatus and/or confinement apparatus substrate. In some embodiments, the one or more optical elements of the signal management system include optical components disposed on the confinement apparatus substrate. These one or more optical elements include passive and/or active optical elements configured to control various parameters of respective manipulation signals and accurately direct respective manipulation signals to respective object locations. The optical elements may include one or more active optical elements that include photodetectors such as photodiode, photomultiplier, charge-coupled device (CCD) sensor, complementary metal oxide semiconductor (CMOS) sensor, Micro-Electro-Mechanical Systems (MEMS) sensor, modulator, and/or other photodetector. In various embodiments, the use of the photonics platform reduces the spatial requirements for free space optics beam path configurations, number of cryogenic and/or vacuum chamber pass throughs, and/or the like. Furthermore, the configuration of the composite confinement apparatus assembly of various embodiments reduces the additional technical problems of signal management systems of larger confinement apparatuses. For example, the photonics platform is scalable with the confinement apparatus such that the signal management system is configurable for accommodating various numbers and/or arrangements/layouts of object locations. Thus, various embodiments provide technical solutions to technical problems regarding how to provide manipulation signals to an array of object locations defined at least in part by a confinement apparatus such that the manipulation signals are efficiently and effectively provided to the object locations, even when the object locations form a two or three-dimensional array.

### Example Quantum Computing System Comprising a Composite Confinement Apparatus Assembly

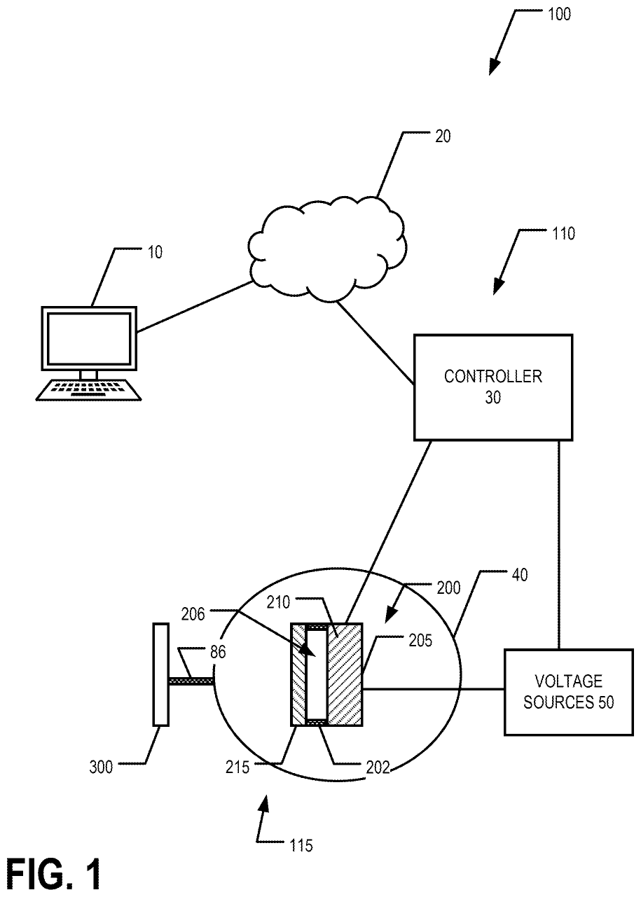

In various embodiments, a composite confinement apparatus assembly is part of a QCCD-based quantum computer. An example of which is illustrated by FIG. 1.

FIG. 1 provides a schematic diagram of an example quantum computing system 100 comprising a composite confinement apparatus assembly 200, in accordance with an example embodiment. In various embodiments, the composite confinement apparatus assembly 200 comprises a confinement apparatus substrate 205 and a photonic platform 215. In various embodiments, the photonic platform 215 and the confinement apparatus substrate 205 are coupled and/or secured in relation to one another via spacing structures 202. In various embodiments, a plurality of electrical components that form and/or define a confinement apparatus 210 are formed and/or disposed on the confinement apparatus substrate 205.

In various embodiments, the composite confinement apparatus assembly 200 is disposed within a cryogenic and/or vacuum chamber 40. For example, the confinement apparatus substrate 205, and photonic platform 215 are disposed within the cryogenic and/or vacuum chamber 40.

In various embodiments, the confinement apparatus 210 and/or confinement apparatus substrate 205 define an apparatus plane. In various embodiments, the photonic platform 215 defines a platform plane. In various embodiments, the platform plane is parallel to the apparatus plane but not coplanar with the apparatus plane. For example, the platform plane and the apparatus plane are separated by a set distance h. In various embodiments, the set distance h is in a range of 5 microns to 500 microns. In an example embodiment, the set distance h is two to five times the height at which the confinement apparatus 210 is configured to confine the quantum objects above a surface of the confinement apparatus substrate 205 configured to face the photonic platform 215.

An open space between the confinement apparatus substrate and the photonic platform defines an confinement apparatus volume 206. The confinement regions generated through the operation of the electrical components of the confinement apparatus 210 (which are formed on the confinement apparatus substrate 205) generate confinement regions that are disposed within the confinement apparatus volume 206 defined between the confinement apparatus and the photonic platform. For example, the object locations defined at least in part by the confinement apparatus are within the confinement apparatus volume 206 defined between the confinement apparatus and the photonic platform.

In various embodiments, the quantum computing system 100 comprises a signal management system. In various embodiments the signal management system comprises the photonic platform 215. For example, the photonic platform 215 comprises one or more photonic components that are used to control parameters (e.g., wavelength, focus, polarization, phase, direction of propagation, and/or intensity) of and/or provide one or more manipulation signals (e.g., electromagnetic signals configured to cause a controlled evolution of the quantum state of a quantum object) to respective object locations. In various embodiments, the signal management system further comprises one or more optical components formed and/or disposed on and/or in the confinement apparatus substrate 205. In an example embodiment, the signal management system includes various optical elements, manipulation sources (e.g., lasers, masers, microwave sources, etc.) 300 and/or the like that are located external to the cryogenic and/or vacuum chamber 40. For example, the one or more optical elements and/or manipulation sources located external to the cryogenic and/or vacuum chamber 40 are coupled to respective beam paths defined at least in part by the photonic components of the photonic platform 215 and/or optical components of the confinement apparatus substrate 205 via optical fibers 86 and/or free space optics, in various embodiments.

In various embodiments, the quantum computing system 100 comprises a computing entity 10 and a quantum computer 110. In various embodiments, the quantum computer 110 comprises a controller 30 and a quantum processor 115. In various embodiments, the quantum processor comprises a cryogenic and/or vacuum chamber 40 enclosing a composite confinement apparatus assembly 200 (e.g., an ion trap-photonic platform assembly), one or more optical elements and/or manipulation sources 300 that are external to the cryogenic and/or vacuum chamber 40, one or more voltage sources 50 configured to provide voltage signals to the electrical components of the composite confinement apparatus assembly 200. In various embodiments the quantum processor 115 further includes one or more photodetectors configured for detecting optical signals generated by quantum objects confined at respective object locations, magnetic field generators configured to for generating a desired magnetic field and/or magnetic field gradient at respective object locations, and/or the like.

In various embodiments, the cryogenic and/or vacuum chamber 40 is a temperature and/or pressure-controlled chamber. For example, the quantum computing system 100 may comprise vacuum and/or temperature control components that are operatively coupled to the cryogenic and/or vacuum chamber 40.

In various embodiments, the quantum computer 110 comprises one or more voltage sources 50. For example, the voltage sources 50 may comprise a plurality of voltage drivers and/or voltage sources and/or at least one radio frequency (RF) driver and/or voltage source. The voltage sources 50 may be electrically coupled to the corresponding electrical components 212 (e.g., electrodes) of the confinement apparatus 210, in an example embodiment. For example, the electric and/or electromagnetic field formed at least in part by applying the voltage signals generated by the voltage source 50 to the electrical components 212 of the confinement apparatus 210 causes and/or forms the confinement region(s) of the confinement apparatus.

In various embodiments, a computing entity 10 is configured to allow a user to provide input to the quantum computer 110 (e.g., via a user interface of the computing entity 10) and receive, view, and/or the like output from the quantum computer 110. The computing entity 10 may be in communication with the controller 30 of the quantum computer 110 via one or more wired or wireless networks 20 and/or via direct wired and/or wireless communications. In an example embodiment, the computing entity 10 may translate, configure, format, and/or the like information/data, quantum computing algorithms and/or circuits, and/or the like into a computing language, executable instructions, command sets, and/or the like that the controller 30 can understand and/or implement.

In various embodiments, the controller 30 is configured to control and/or be in electrical communication with the voltage sources 50, cryogenic system and/or vacuum system controlling the temperature and/or pressure within the cryogenic and/or vacuum chamber 40, manipulation sources 60, photodetectors, and/or other systems controlling various environmental conditions (e.g., temperature, pressure, magnetic field, and/or the like) within the cryogenic and/or vacuum chamber 40 and/or configured to manipulate and/or cause a controlled evolution of quantum states of one or more quantum objects confined by the confinement apparatus. For example, the controller 30 may cause a controlled evolution of quantum states of one or more quantum objects within the confinement apparatus to execute a quantum circuit and/or algorithm. For example, the controller 30 may cause a reading procedure to be performed, possibly as part of executing a quantum circuit and/or algorithm. In various embodiments, the quantum objects confined within the confinement apparatus are used as qubits of the quantum processor 115 and/or quantum computer 110.

### Example Composite Confinement Apparatus Assembly

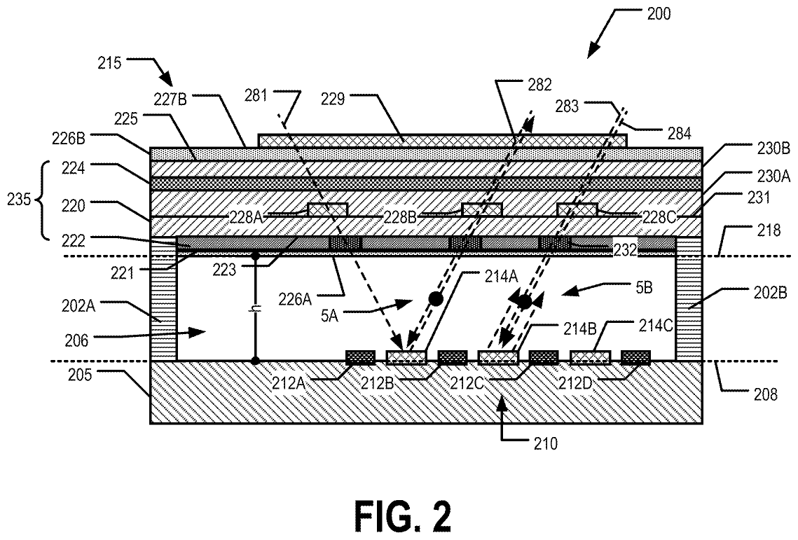

FIG. 2 provides a schematic cross-section view of an example embodiment of a composite confinement apparatus assembly 200. The composite confinement apparatus assembly 200 includes a confinement apparatus 210 formed on a confinement apparatus substrate 205 and a photonic platform 215. The photonic platform 215 and the confinement apparatus substrate 205 are coupled to one another and/or secured into relationship with one another via spacing structures 202 (e.g., 202A, 202B).

In various embodiments, the confinement apparatus 210 and/or confinement apparatus substrate 205 define an apparatus plane 208. In various embodiments, the photonic platform 215 defines a platform plane 218. In various embodiments, the platform plane 218 is parallel to the apparatus plane 208, but not coplanar with the apparatus plane 208. For example, the platform plane 218 and the apparatus plane 208 are separated by a set distance h. The relationship between the platform plane 218 and the apparatus plane 208 is controlled and/or maintained by the spacing structures 202. For example, the set distance h and/or the parallel relationship between the platform plane 218 and the apparatus plane 208 is controlled and/or maintained by the spacing structures 202. An confinement apparatus volume 206 is defined and/or disposed between the confinement apparatus substrate 205 and the photonic platform 215. The confinement regions generated through the operation of the electrical components 212 (e.g., 212A, 212B, 212C, 212D) of the confinement apparatus 210 (which are formed on the confinement apparatus substrate 205) generate confinement regions that are disposed within the confinement apparatus volume 206 defined between the confinement apparatus 210 and the photonic platform 215. For example, the object locations 5 (e.g., 5A, 5B) defined at least in part by the confinement apparatus 210 are within the confinement apparatus volume 206 defined between the confinement apparatus 210 and the photonic platform 215.

In various embodiments, the composite confinement apparatus assembly 200 comprises a confinement apparatus 210. The confinement apparatus 210 comprises a plurality of electrical components 212 (e.g., 212A, 212B, 212C, 212D) such as electrodes, in an example embodiment, that are configured to generate a confining potential that defines one or more confinement regions of the confinement apparatus 210. In various embodiments, the plurality of electrical components 212 of the confinement apparatus 210 are formed and/or disposed on a confinement apparatus substrate 205. For example, the controller 30 may control the voltage sources 50 to provide electrical signals to the electrical components 212 of the confinement apparatus 210 such that the electrical components 212 generate a confining potential. The confining potential is configured to confine a plurality of quantum objects within one or more confinement regions defined by the confinement apparatus 210 and disposed within the confinement apparatus volume 206 between the confinement apparatus substrate 205 and the photonic platform 215. In various embodiments, the electrical components 212 and/or confining potential are configured to define a plurality of object locations within the confinement region(s) and/or confinement apparatus volume 206.

In various embodiments, the object locations are disposed in a one-dimensional or two-dimensional lay out. For example, in an example embodiment, the object locations are disposed along an axis of a linear configuration of electrical components 212 of the confinement apparatus 210. In another example embodiment, the object locations are disposed in a two-dimensional array or layout defined by a two-dimensional configuration of electrical components 212 of the confinement apparatus 210. An example confinement apparatus comprising a linear configuration of electrical components (e.g., electrodes) is described by U.S. application Ser. No. 16/717,602, filed Dec. 17, 2019, though various other confinement apparatuses having linear electrical component configurations may be used in various embodiments. Some example confinement apparatuses having two-dimensional electrical component configurations are described by U.S. application Ser. No. 17/533,587, filed Nov. 23, 2021, and U.S. application Ser. No. 17/810,082, filed Jun. 30, 2022, though various other confinement apparatuses having two-dimensional electrical component configurations may be used in various embodiments. The contents of U.S. application Ser. No. 16/717,602, filed Dec. 17, 2019, U.S. application Ser. No. 17/533,587, filed Nov. 23, 2021, U.S. application Ser. No. 17/810,082, filed Jun. 30, 2022, are incorporated herein by reference in their entireties.

In various embodiments, the voltage sources 50 provide respective electrical signals to the respective electrical components 212 (e.g., electrodes) of the confinement apparatus 210, such that a confining potential is formed. Based on the contours and time evolution of the confining potential (controlled by the controller 30 via controlling the operation of the voltage sources 50) one or more quantum objects are confined at respective object locations 5, moved between respective object locations, and/or the like. When a quantum object is located at an object location, one or more functions (e.g., quantum computing functions) may be performed on the quantum object. An example function that may be performed on quantum object is photoionization of the quantum object. For example, a manipulation signal may be applied to the quantum object (e.g., an atom or molecule) to photo-ionize the quantum object.

Another example function that may be performed on a quantum object is state preparation of the quantum object. For example, one or more manipulation signals may be applied to the quantum object to prepare the quantum object in a particular quantum state. For example, the particular quantum state may be a state within a defined qubit space used by the quantum computer such that the quantum object may be used as a qubit of the quantum computer.

Another example function that may be performed on a quantum object is reading a quantum state of the quantum object. For example, a manipulation signal (e.g., a reading signal) may be applied to the quantum object. When the quantum object's wave function collapses into a first state of the qubit space, the quantum object will fluoresce in response to the reading signal being applied thereto. When the quantum object's wave function collapses into a second state of the qubit space, the quantum object will not fluoresce in response to the reading signal being applied thereto. A photodetector configured to receive signals emitted by a quantum object disposed at a respective object location 5 may then detect whether or not the quantum object fluoresced such that the quantum state of the quantum object is determined.

Another example function that may be performed on a quantum object is cooling the quantum object or a quantum object crystal comprising the quantum object. A quantum object crystal is a pair or set of quantum objects where at least one of the quantum objects of the quantum object crystal is qubit quantum object used as a qubit of the quantum computer and at least one quantum objects of the quantum object crystal is used to perform sympathetic cooling of the qubit quantum object. For example, a manipulation signal (e.g., a cooling signal or a sympathetic cooling signal) may be applied to the quantum object or quantum object crystal to cause the (qubit) quantum object to be cooled (e.g., reduce the vibrational and/or other kinetic energy of the (qubit) quantum object).

Another example function that may be performed on a quantum object is shelving the quantum object. In various embodiments, quantum objects in the second state of the qubit space may be shelved during the performance of a reading function. For example, a shelving operation may comprise causing the quantum state of a quantum object in the second state of the qubit space to evolve to an at least meta-stable state outside of the qubit space while a reading operation is performed. An example shelving process is describe by U.S. application Ser. No. 17/583,308, filed Jan. 25, 2022, though various other shelving processes may be used in various embodiments. In various embodiments, the shelving of a quantum object is performed by applying one or more manipulation signals to the quantum object to cause the quantum object's quantum state to evolve to an at least meta-stable state outside of the qubit space when the quantum object is in the second state of the qubit space.

Another example function that may be performed on a quantum object is (optical) repumping of the quantum object. In various embodiments, repumping of the quantum object comprises applying one or more manipulation signals 61 to the quantum object to cause the quantum state of the quantum object to evolve to an excited state.

Another example function that may be performed on a quantum object is performing a single qubit gate on the quantum object. For example, one or more manipulation signals may be applied to the quantum object to perform a single qubit quantum gate (e.g., a single qubit logical function) on the quantum object.

Another example function that may be performed on a quantum object is performing a two qubit gate on the quantum object. For example, one or more manipulation signals may be applied to a pair or set of quantum objects that includes the quantum object to perform a two qubit (or three, four, or more) quantum gate (e.g., a multiple qubit logical function) on the quantum object and the at least one other quantum object.

In various embodiments, one or more optical components 214 (e.g., 214A, 214B, 214C) are formed on the confinement apparatus substrate 205. In various embodiments, the one or more optical components 214 comprise flat optics (e.g., metasurfaces, DOEs), guided mode photonics (e.g., waveguides), microfabricated lenses, and/or the like. For example, in various embodiments, the photonic components and/or optical components of the signal management system comprise one or more DOEs, passive metasurfaces, active metasurfaces, optical modulators, low loss waveguides, amplifiers, on-chip lasers, photodetectors, grating couplers, beam splitters, edge couplers, optical local oscillators, tapers, reference cavities, optical sinks, light absorbing structures, anti-reflection coatings, optical routing elements, resonant structures, and/or the like. In various embodiments, the one or more optical components 214 are configured to control parameters (e.g., wavelength, focus, polarization, phase, direction of propagation, and/or intensity) and/or provide manipulation signals to respective object locations. For example, an optical component 214 is associated with a respective object location 5 such that the optical component 214 is part of an optical path for providing a respective manipulation signal to the respective object location to cause a respective function to be performed one or more quantum objects disposed at the respective object location.

The composite confinement apparatus assembly 200 further includes a photonic platform 215. The photonic platform 215 comprises photonic components. In the illustrated embodiments, the photonic components of the photonic platform 215 include cladded photonic components (e.g., 228A, 228B, 228C) and exposed photonic components 229. In various embodiments, the cladded photonic components include one or more waveguide layers 224. In various embodiments, the one or more photonic components (e.g., cladded photonic components 228 and/or exposed photonic components 229) comprise flat optics (e.g., metasurfaces, DOEs), guided mode photonics (e.g., waveguides), microfabricated lenses, and/or the like. For example, in various embodiments, the photonic components of the signal management system comprise one or more DOEs, passive metasurfaces, active metasurfaces, optical modulators, low loss waveguides, amplifiers, on-chip lasers, photodetectors, grating couplers, beam splitters, edge couplers, optical local oscillators, tapers, reference cavities, optical sinks, light absorbing structures, anti-reflection coatings, optical routing elements, resonant structures, and/or the like. In various embodiments, the one or more photonic components are configured to control parameters (e.g., wavelength, focus, polarization, phase, direction of propagation, and/or intensity) and/or provide manipulation signals to respective object locations. For example, a photonic component is associated with a respective object location 5 such that the photonic component is part of an optical path for providing a respective manipulation signal to the respective object location to cause a respective function to be performed one or more quantum objects disposed at the respective object location.

In various embodiments, the photonic platform 215 comprises a photonic platform substrate 220. In various embodiments, the photonic platform substrate 220 is transparent to light and/or electromagnetic signals characterized by a wavelength within a particular wavelength range. In various embodiments, the manipulation signals provided to the respective object locations are characterized by wavelengths within the particular wavelength range. For example, the photonic platform substrate 220 is transparent to the manipulation signals, in various embodiments. In various embodiments, one or more waveguides, waveguide layers 224, and/or cladded photonic components 228 are formed on the photonic platform substrate 220. Cladding layers 230 (e.g., 230A, 230B) may then be deposited and/or formed on the one or more waveguides, waveguide layers 226, and/or cladded photonic components 228 so as to clad the one or more waveguides, waveguide layers 226, and/or cladded photonic components 228. In various embodiments, several alternating layers of waveguides, waveguide layers 226, and/or cladded photonic components 228 and corresponding cladding layers 230 may be sequentially formed on the photonic platform substrate 220 to form component-integrated platform substrate 235. In various embodiments, the cladding layers 230 and the photonic platform substrate 220 are formed of the same material and/or material that has similar optical properties (e.g., similar refractive indices, absorption coefficients, and/or transmission coefficients for manipulation signals characterized by wavelengths within the particular wavelength range).

For example in the illustrated example embodiment, a plurality of cladded photonic components 228 are formed on a first surface 231 of the photonic platform substrate 220. The first surface 231 of the photonic platform substrate 220 is configured to face away from the confinement apparatus substrate 205, in the illustrated embodiment. A first cladding layer 230A is then deposited and/or formed on the first surface 231 of the photonic platform substrate 220 and the cladded photonic components 228 formed thereon. A waveguide layer 224 is formed on the first cladding layer 230A and a second cladding layer 230B is formed on the waveguide layer 224. Various layers of waveguides and/or other photonic components (e.g., flat optics, guided mode photonics, microfabricated lenses) and corresponding cladding layers may be formed on the first surface 231 of the photonic platform substrate 220, as appropriate for the application, to form the component-integrated platform substrate 235.

In various embodiments, the photonic platform substrate 220 and/or cladding layer(s) 230 comprises glass, sapphire, or fused quartz. Various other materials may be used for forming the photonic platform substrate 220 and/or cladding layer(s) 230, in various embodiments, as appropriate for the application. For example, the photonic platform substrate 220 and/or cladding layer(s) 230 comprises silicon dioxide, silicon nitride, aluminum oxide, aluminum nitride, tantalum pentoxide, hafnia, or silicon carbide, etc.

In various embodiments, the cladded photonic components 228, waveguides, and/or waveguide layers 224 are configured to cause respective manipulation signals to be incident on respective object locations 5 defined by the confinement apparatus 210. In various embodiments, the cladded photonic components 228, waveguides, and/or waveguide layers 224 are configured to control parameters (e.g., wavelength, focus, polarization, phase, direction of propagation, and/or intensity) of respective manipulation signals provided to respective object locations 5.

In various embodiments, the cladded photonic components 228, waveguides, waveguide layers 224, and cladding layers are formed on the second surface 223 of the photonic platform substrate 220 to form the component-integrated platform substrate 235 (e.g., rather than the first surface 231). In various embodiments, respective cladded photonic components 228, waveguides, waveguide layers 224, and cladding layers are formed on both the first surface 231 and the second surface 223 of the photonic platform substrate 220 to form the component-integrated platform substrate 235.

In various embodiments, an anti-reflection coating 226B is applied to the first surface 225 of the component-integrated platform substrate 235. For example, the anti-reflection coating 226B may be applied, formed, and/or deposited on the first surface 225 of the component-integrated platform substrate 235. In various embodiments, the anti-reflection coating 226B is engineered to minimize and/or reduce the reflection of light off of the first surface 225. For example, the anti-reflection coating 226B is configured, engineered, and/or designed, to increase and/or maximize the transmission coefficient across the first surface 225. In various embodiments, the first surface 225 of the component-integrated platform substrate 235 is configured to face away from the confinement apparatus substrate 205.

I In various embodiments, exposed photonic components 229 are disposed on the first surface 225 of the component-integrated platform substrate 235. For example, the exposed photonic components 229 are formed on the anti-reflection coating 226B, in an example embodiment. In various embodiments, the exposed photonic components 229 include one or more of flat optics (e.g., metasurfaces, DOEs), guided mode photonics (e.g., waveguides), microfabricated lenses, and/or the like. For example, in various embodiments, the exposed photonic components comprise DOEs, passive metasurfaces, active metasurfaces, optical modulators, low loss waveguides, amplifiers, on-chip lasers, photodetectors, grating couplers, beam splitters, edge couplers, optical local oscillators, tapers, reference cavities, optical sinks, light absorbing structures, optical routing elements, resonant structures, and/or the like. For example, in various embodiments, the exposed photonic components 229 include one or more metasurfaces, a metasurface array, one or more lenses, a lenslet array, and/or the like. In an example embodiment, the exposed photonic component 229 is configured to couple manipulation signals into the photonic platform 215.

A second surface 223 of the photonic platform substrate 220 and/or component-integrated platform substrate 235 is configured to face the confinement apparatus substrate 205. In various embodiments, a conductive layer 222 is disposed, deposited, and/or formed on the second surface 223 of the photonic platform substrate 220 and/or component-integrated platform substrate 235. In various embodiments, the conductive layer 222 comprises an electrically conductive material. In various embodiments, the conductive layer 222 is configured to be held at a fixed electric potential. For example, the conductive layer 222 may be in electrical communication with a ground and/or a voltage source configured to cause the conductive layer 222 to be held at a fixed electric potential.

In various embodiments, at least one or more sections of the conductive layer 222 are transparent for electromagnetic radiation characterized by wavelengths within the particular wavelength range. In various embodiments, the conductive layer 222 is a transparent conductive film and/or layer. For example, the conductive layer 222 may be formed of indium tin oxide (ITO) or another transparent conductive material. In various embodiments, the conductive layer 222 comprises one or transparent sections 232. For example, the conductive layer 222 may be formed of a non-transparent conductive material. The one or more transparent sections 232 may be windows opened in the non-transparent conductive material (e.g., via etching, masked or lithographic deposition of the non-transparent conductive material, and/or the like). In various embodiments, the one or more transparent sections 232 are formed of a transparent conductive material, are empty openings in the conductive material of the conductive layer 222, and/or the like.

In various embodiments, a confinement apparatus-facing surface 221 of the conductive layer 222 (and/or portions thereof) has anti-reflective characteristics. In various embodiments, an anti-reflection coating 226A is applied, deposited, and/or disposed on the confinement apparatus-facing surface 221 of the conductive layer 222. In various embodiments, the anti-reflection coating 226A is engineered to minimize and/or reduce the reflection of light off of the confinement apparatus-facing surface 221. For example, the anti-reflection coating 226A is configured, engineered, and/or designed, to increase and/or maximize the transmission coefficient across the confinement apparatus-facing surface 221. In various embodiments, the confinement apparatus-facing surface 221 is configured to face the confinement apparatus substrate 205.

In various embodiments, the conductive layer 222 comprises a plurality of patterned electrodes. For example, in an example embodiment, the conductive layer 222 comprises a plurality of patterned electrodes configured to form a confinement apparatus. For example, the conductive layer 222 may comprise a plurality of patterned electrodes configured to form a secondary confinement apparatus that is independent (or largely independent) of the confinement apparatus 205 formed on the confinement apparatus substrate 205. For example, the conductive layer 222 may comprise a plurality of patterned electrodes configured to form, in coordination with the electrode components 212 formed on the confinement apparatus 205 to form a three-dimensional (3D) confinement apparatus.

The photonic components (e.g., cladded photonic components 228, exposed photonic components 229, and/or other photonic components) of the photonic platform 215 are configured to provide various manipulation signals to respective object locations 5 defined at least in part by the confinement apparatus 210. FIG. 2 illustrates two example strategies for providing various manipulation signals to respective object locations 5.

For example, two manipulation signals are provided such that the manipulation signals are co-axial and counter-propagating when they are incident on the first object location 5A during an overlapping time period. The first manipulation signal 281 and the second manipulation signal 282 are provided during an overlapping time period such that the first manipulation signal 281 and the second manipulation signal 282 are both incident on the first object location 5A during a particular time window. For example, a first manipulation signal 281 is provided to the photonic platform 215 such that the first manipulation signal 281 is conditioned (e.g., has one or more parameters thereof controlled) by the exposed photonic component 229 and the first cladded photonic component 228A. The first manipulation signal 281 is then reflected and/or further conditioned by a first optical component 214A. A second manipulation signal 282 is provided to the photonic platform 215 such that the second manipulation signal 282 is conditioned (e.g., has one or more parameters thereof controlled) by the exposed photonic component 229 and the second cladded photonic component 228B. The first manipulation signal 281 and the second manipulation signal 282 pass through the first object location 5A such that the first manipulation signal 281 and the second manipulation signal are co-axial, but propagating in opposite directions. In various embodiments, such a configuration may be used to perform a two-qubit gate and/or other quantum logical operation at the first object location 5A. For example, the co-axial counter-propagating (reflected) first manipulation signal 281 and the second manipulation signal 282 may be used to perform a two-qubit gate and/or other quantum logical operation at the first object location 5A.

In another example, at a second object location 5B, a third manipulation signal 283 and a fourth manipulation signal 284 are provided along a common optical path to provide coaxial counter-propagating manipulation signals at the second object location 5B. The third manipulation signal 283 and the fourth manipulation signal 284 are provided during an overlapping time period such that the third manipulation signal 283 and the fourth manipulation signal 284 are both incident on the second object location 5B during a particular time window. For example, the third manipulation signal 283 and the fourth manipulation signal 284 are both provided to the photonic platform 215 such that the third manipulation signal 283 and the fourth manipulation signal 284 are conditioned (e.g., have one or more parameters thereof controlled) by the exposed photonic component 229 and the third cladded photonic component 228C. The third manipulation signal 283 and the fourth manipulation signal 284 are reflected and/or further conditioned by a second optical component 214B. The reflect third manipulation signal 283 and the reflected fourth manipulation signal 284 pass back through the second object location 5B to provide the co-axial counter-propagating manipulation signals (e.g., the third manipulation signal 283 interacting with the reflected fourth manipulation signal and the fourth manipulation signal 284 interacting with the reflected third manipulation signal). For example, in an example embodiment, the second optical component 214B is a retroreflector. In various embodiments, such a configuration may be used to perform a two-qubit gate and/or other quantum logical operation at the second object location 5B. For example, the co-axial counter-propagating third manipulation signal and reflected fourth manipulation signal and the co-axial and counter-propagating reflected third manipulation signal and the fourth manipulation signal may be used to perform a two-qubit gate and/or other quantum logical operation at the second object location 5B. In an example embodiment, wherein the second optical component 214B is a retroreflector, the co-axial counter-propagating third manipulation signal and reflected fourth manipulation signal and the co-axial and counter-propagating reflected third manipulation signal and the fourth manipulation signal generate a phase-stable interference pattern.

In various embodiments, the composite confinement apparatus assembly 200 further includes optical sinks. For example, the photonic platform 215 may include one or more photonic platform sinks configured to act as optical sinks. In another example, the confinement apparatus substrate 205 includes one or more apparatus substrate sinks configured to act as optical sinks. For example, the optical sinks of the composite confinement apparatus assembly 200 are configured to enable and/or facilitate removal of and/or permit the exiting of photons from the confinement apparatus volume 206 disposed between the photonic platform 215 and the confinement apparatus substrate 205.

For example, the one or more optical sinks of the composite confinement apparatus assembly 200 are configured to reduce undesired photons (e.g., scattered photons that are no longer part of a manipulation signal) from the confinement apparatus volume 206 between the quantum object confinement apparatus and the photonic platform for reducing an undesired illumination of one or more untargeted quantum objects located between the quantum object confinement apparatus and the photonic platform.

In various embodiments, the photonic platform 215 is secured to confinement apparatus substrate 205 via one or more spacing structures 202. In various embodiments, the spacing structures 202 are solid material pillars. For example, the spacing structures 202 are formed by etching away a portion of a spacer wafer, in various embodiments. For example, a spacer wafer bonded to the photonic platform substrate 220 may be etched to form the open space of the confinement apparatus volume 206 and the spacing structures 202.

In various embodiments, the spacing structures 202 are and/or comprise actuators. For example, the spacing structures 202 may be actuators that are operable to adjust a relative positioning between the photonic platform 215 and the confinement apparatus substrate 205. In an example embodiment, each actuator is coupled to a respective motor configured to control actuation of the respective actuator. In an example embodiment, each actuator comprises one or more piezoelectric actuators. The piezoelectric actuators are configured to adjust the distance between photonic platform 215 and the confinement apparatus substrate 205 and/or to adjust one or more angles between the apparatus plane 208 and the platform plane 218. For example, the nano-positioners may be used to perform dynamic alignment between the photonic platform 215 and the confinement apparatus substrate 205.

In an example embodiment, the photonic platform 215 and the confinement apparatus substrate 205 are secured to one another via a nano-positioner mounting apparatus. For example, a nano-positioning system such as a nano-positioner mounting apparatus may be used to secure the photonic platform 215 to the confinement apparatus substrate 205 in an adjustable manner.

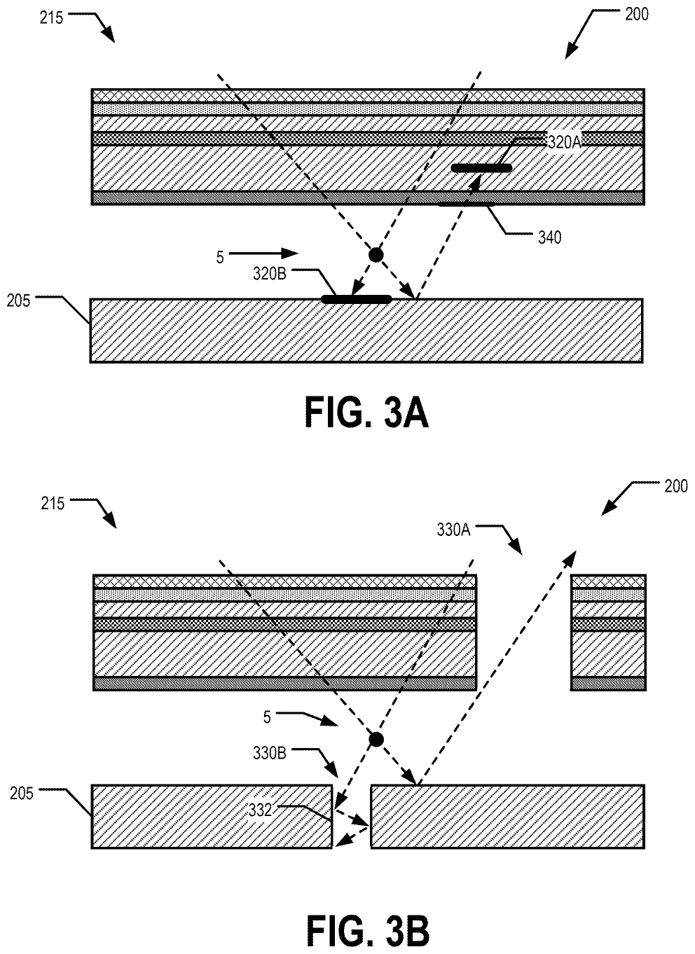

FIGS. 3A and 3B illustrate example embodiments where the composite confinement apparatus assembly 200 includes various types of optical sinks.

FIG. 3A illustrates a portion of a composite confinement apparatus assembly 200 where the photonic platform comprises one or more photonic platform sinks that include platform absorbing sink 320A and the confinement apparatus substrate 205 includes one or more apparatus substrate sink that include apparatus absorbing sink 320B. For example, in various embodiments, one or more optical sinks (e.g., photonic platform sinks and/or apparatus substrate sinks) are absorbing optical sinks configured to absorb and/or significantly attenuate light incident thereon. For example, an absorbing optical sink comprises a photon absorber. In example embodiments, the photon absorber is positioned on a surface of the quantum object confinement apparatus or photonic platform and/or at least partially embedded within the confinement apparatus substrate 205 or photonic platform substrate 220. For example, an absorbing optical sink is configured to absorb and/or attenuate light characterized by wavelengths within the particular wavelength range (e.g., the particular wavelength range for which the photonic platform substrate 220 is transparent to) or a wavelength range that includes the particular wavelength range. For example, the absorbing optical sinks may be metal or non-transparent material depositions, nanotube arrays, and/or other structures configured to absorb and/or attenuate light characterized by wavelengths within the particular wavelength range.

FIG. 3B illustrates a portion of a composite confinement apparatus assembly 200 where the photonic platform comprises one or more photonic platform sinks that include platform hole sink 330A and the confinement apparatus substrate 205 includes one or more apparatus substrate sinks that include apparatus hole sink 330B. For example, in various embodiments, one or more optical sinks (e.g., photonic platform sinks and/or apparatus substrate sinks) are holes in and/or through the respective platform/substrate that are configured and/or positioned to allow light exit the confinement apparatus volume 206 between the confinement apparatus substrate 205 and the photonic platform 215 by passing through the respective hole. In various embodiments, the holes in and/or through the respective platform/substrate may include a through hole, depression/indent, or groove in the surface of the respective platform/substrate. For example, a hole may be an area or volume within the respective platform/substrate that is a void and/or material free region. In another example, a hole sink 330 is a transparent window (e.g., a conductive transparent window, in an example embodiment formed of ITO, for example) configured and/or positioned to allow light to exit the confinement apparatus volume 206 by passing through the respective window into an opening and/or void in the respective platform/substrate or into the material of the respective platform/substrate. For example, a hole sink may be positioned and shaped to enable light to exit the confinement apparatus volume 206 between the confinement apparatus substrate 205 and the photonic platform 215 directly, as for the illustrated platform hole sink 330A. In another example, a hole sink may be positioned and shaped to cause light exiting the confinement apparatus volume 206 via the hole to reflect off the surfaces 332 of the hole, as for the illustrated apparatus hole sink 330B. The surfaces 332 of the hole are configured to partially attenuate the light reflecting there off, in an example embodiment. In another example embodiment, the surfaces 332 of the hole are configured to efficiently reflect the light reflecting there off such that heating of the respective substrate due to light exiting the hole sink is minimal.

Another example optical sink that may be disposed on and/or in a confinement apparatus substrate 205 and/or photonic platform 215 is a engineered coating 340 with high optical transmittance, as shown in FIG. 3A. In an example embodiment, the engineered coating 340 is the anti-reflection coating 226A. In another example embodiment, the engineered coating 340 is an additional coating configured to cause light in the particular wavelength range to be transmitted across the respective substrate surface with high efficiency and/or with minimal reflection.

In various embodiments, a composite confinement apparatus assembly 200 includes multiple types of optical sinks configured to reduce the undesired photons within the confinement apparatus volume 206. For example, in an example embodiment, the one or more optical sinks of the composite confinement apparatus assembly 200 include one or more of a hole sink through a respective one of the photonic platform 215 or the confinement apparatus substrate 205 and configured to pass at least a first portion of undesired photons within the confinement apparatus volume through the respective one of the photonic platform 215 or the confinement apparatus substrate 205, an engineered coating on a surface of a respective one of the photonic platform 215 or the confinement apparatus substrate 205 with high optical transmittance configured to transmit at least a second portion of undesired photons within the confinement apparatus volume through the surface, and a photon absorber disposed on and/or in a respective one of the photonic platform 215 or the confinement apparatus substrate 205 and configured to absorb at least a third portion of the undesired photons within the confinement apparatus volume. In various embodiments, a portion of undesired photons may refer to any quantifiable percentage of the undesired photos. For example, the quantifiable percentage value may be any real number between 0 and 100.

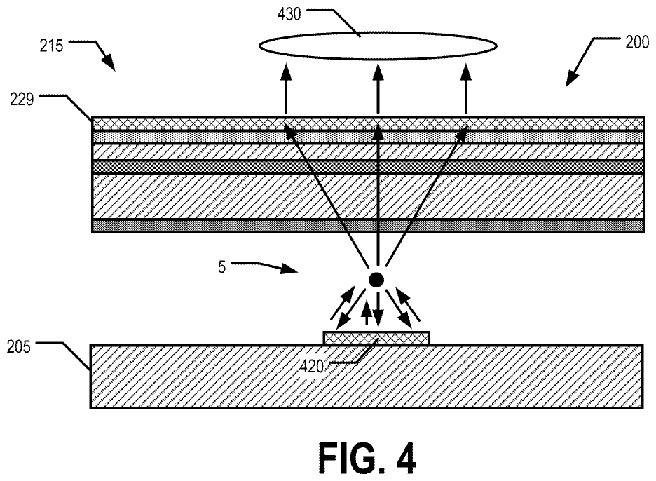

In various embodiments, the composite confinement apparatus assembly 200 includes components configured to aid in collection of light emitted by a quantum object disposed at a respective object location 5. For example, FIG. 4 illustrates a portion of an example composite confinement apparatus assembly 200 that comprises an optical component 214 configured as a collection optical component 420. In the illustrated example, the collection optical component 420 is configured to reflect light emitted by a quantum object disposed at the object location 5 back through the object location 5. The reflected light is then incident on the photonic platform 215. One or more photonic components of the photonic platform 215 may be configured to collimate the reflected light and/or otherwise directed the reflected light toward a collection system 430. For example, in the illustrated embodiment, the exposed photonic component 229 is configured to collimate the reflected light and directed reflected light toward the collection system 430. In various embodiments, the collection system 430 comprises a photodetector and lenses, optical fibers, waveguides, and/or the like configured to transport the reflected light to the photodetector. In an example embodiment, the collection system 430 consists of a photon detector disposed and/or positioned such that the reflected light is incident thereon. In an example embodiment, the photodetector is a photodiode, photomultiplier, charge-coupled device (CCD) sensor, complementary metal oxide semiconductor (CMOS) sensor, Micro-Electro-Mechanical Systems (MEMS) sensor, modulator, and/or other photodetector that is sensitive to light at an expected fluorescence wavelength of the quantum objects the composite confinement apparatus assembly is configured to confine.

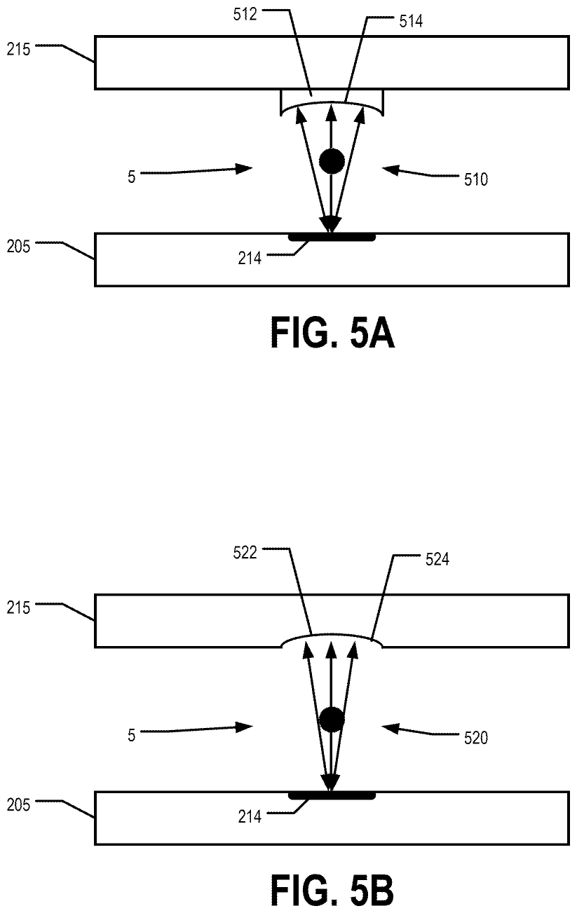

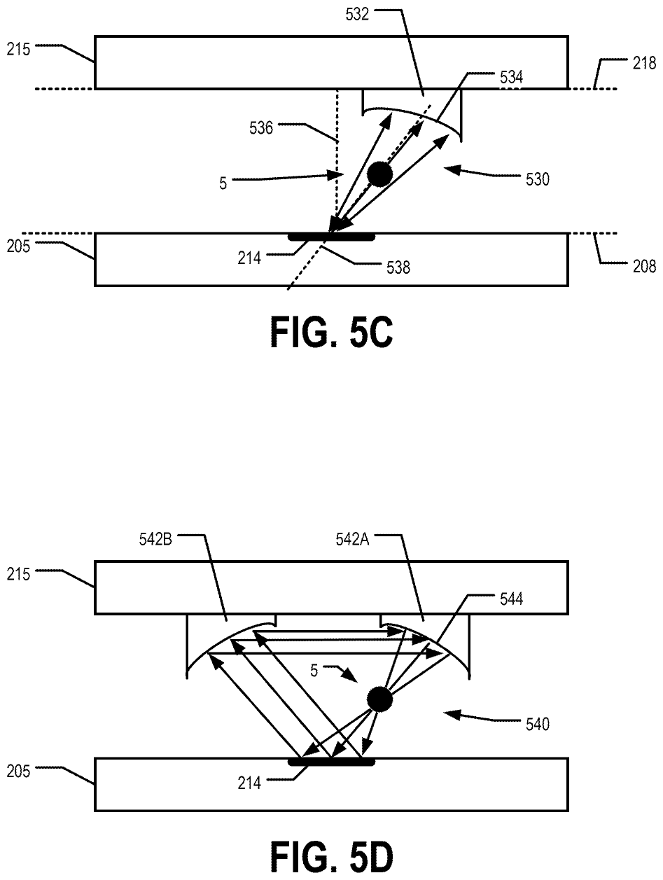

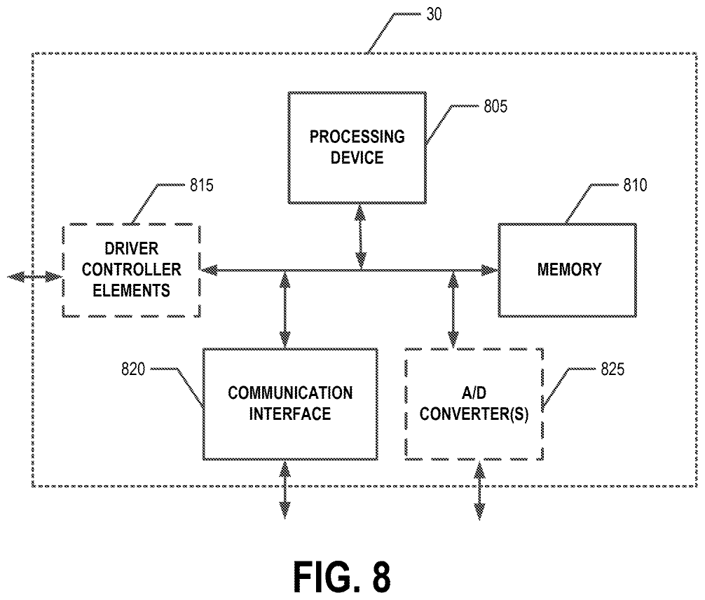

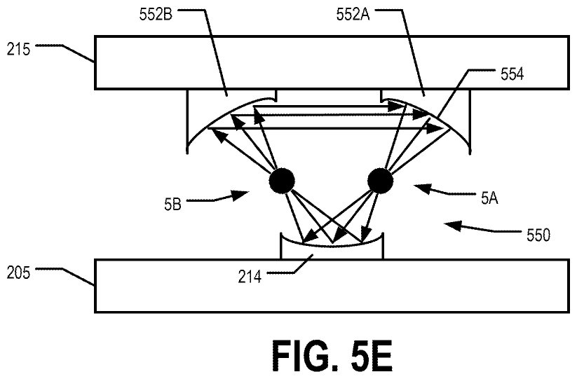

In various embodiments, the photonic platform includes one or more surface photonic components. FIGS. 5A, 5B, 5C, and 5D illustrate some example surface photonic components. As used herein a surface photonic component is a photonic component that is formed on or in the confinement apparatus-facing surface 221. For example, portions of the confinement apparatus-facing surface 221 may not include an anti-reflection coating 226A and may be configured to reflect light incident thereon. In various embodiments, the surface photonic components are mirrors and/or other reflective components, diffractive optical elements, metasurfaces, and/or the like.

For example, in various embodiments, a surface photonic component formed on and/or in the confinement apparatus-facing surface 221 and an optical component 214 disposed on the confinement apparatus substrate 205 may be used to define a cavity with the object location 5 disposed within the cavity. For example, the cavity may be a Fabre-Perot cavity. In various embodiments, the cavity may be configured to address two or more quantum objects and/or to include two or more quantum object locations therein.

For example, FIG. 5A illustrates a portion of an example composite confinement apparatus assembly 200 that includes a cavity 510 formed between surface photonic component 512 and optical component 214. For example, the surface photonic component 512 extends out form the confinement apparatus-facing surface 221. The surface photonic component 512 includes a reflective surface 514 configured to direct light incident thereon back toward the optical component 214.

FIG. 5B illustrates a portion of an example composite confinement apparatus assembly 200 that includes a cavity 520 formed between a recessed surface photonic component 522 and optical component 214. For example, the surface photonic component 522 is disposed in and/or formed by a concave portion of the confinement apparatus-facing surface 221. The surface photonic component 522 includes a reflective surface 524 configured to direct light incident thereon back toward the optical component 214.

FIG. 5C illustrates a portion of an example composite confinement apparatus assembly 200 that includes an angled cavity 530. For example, the angled cavity 530 extends along a cavity axis 538 that is not parallel to the normal 536 to the apparatus plane 208 and/or the platform plane 218. For example, a surface photonic component 532 is disposed on and/or formed in the confinement apparatus-facing surface 221. The surface photonic component 532 includes a reflective surface 534 configured to direct light incident thereon back toward the optical component 214.

The example cavities 510, 520, and 530 are each configured to have counter-propagating light therein. This results in interference fringes within the respective cavity. In various embodiments, an object location 5 disposed within a cavity 510, 520, 530 is located at a node, anti-node, or between modes of the interference fringes to cause respective functions of a quantum computer, for example, to be performed on a quantum object disposed at the object location as a result of the counter-propagating light and/or interference fringes interacting with the quantum object.

FIG. 5D illustrates a portion of an example composite confinement apparatus assembly 200 that includes a mirror ring cavity 540. The mirror ring cavity 540 is defined by two surface photonic components 542A, 542B and optical component 214 formed on and/or in the confinement apparatus substrate 205. As illustrated, the mirror ring cavity 540 does not include counter propagating light. However, a second beam could be provided into the mirror ring cavity 540 to cause counter-propagating light and corresponding interference fringes to be present in the mirror ring cavity 540. each of the surface photonic components 542A, 542B include a respective reflective surface 544. The respective reflective surfaces 544 extend from the confinement apparatus-facing surface 221 or are embedded within the confinement apparatus-facing surface 221.

FIG. 5E illustrates a portion of an example composite confinement apparatus assembly 200 that includes a two-focal point mirror ring cavity 550. The two-focal point mirror cavity ring 550 is defined by two surface photonic components 552A, 552B and optical component 214 formed on and/or in the confinement apparatus substrate 205. For example, the two-focal point mirror ring cavity 550 is configured to have two focal points. A first object location 5A is located at a first focal point of the two focal points and a second object location 5B is located at a second focal point of the two focal points. A first quantum object disposed at the first object location 5A and a second quantum object disposed at the second object location 5B may be coupled and/or entangled by light within the two-focal point mirror ring cavity 550. In various embodiments, a multi-focal point mirror ring cavity includes more than two focal points (e.g., 3 focal points, 4 focal points, and/or the like).

As illustrated, the two-focal point mirror ring cavity 550 does not include counter propagating light. However, a second beam could be provided into the two-focal point mirror cavity ring 550 to cause counter-propagating light and corresponding interference fringes to be present in the two-focal point mirror ring cavity 550. Each of the surface photonic components 552A, 552B include a respective reflective surface 554. The respective reflective surfaces 554 extend from the confinement apparatus-facing surface 221 or are embedded within the confinement apparatus-facing surface 221.

In various embodiments, a composite confinement apparatus assembly 200 may include one or more of cavities 510, 520, 530, 540, 550. For example, the composite confinement apparatus assembly 200 may include a plurality of cavities disposed in accordance with respective object locations 5 and that are configured for performance of various functions of a quantum computer including the composite confinement apparatus assembly 200.

In various embodiments, a composite confinement apparatus assembly 200 is and/or is part of an optics-integrated confinement apparatus system as described by U.S. Application No. 63/378,124, filed Oct. 3, 2022, the content of which is incorporated herein by reference in its entirety. For example, the composite confinement apparatus assembly may further include one or more bridge chips, the confinement apparatus substrate 205 may be a confinement apparatus chip, and/or the photonic platform 215 may be a delivery chip, in an example embodiment.

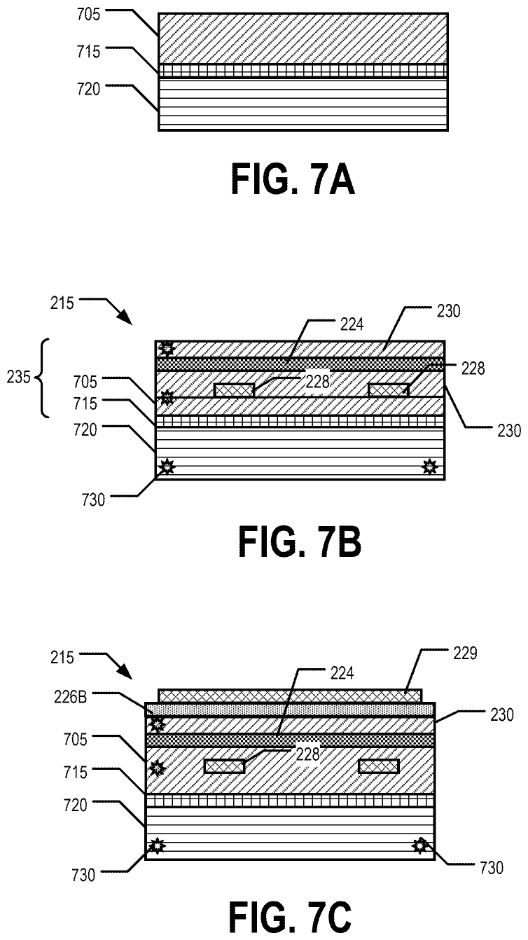

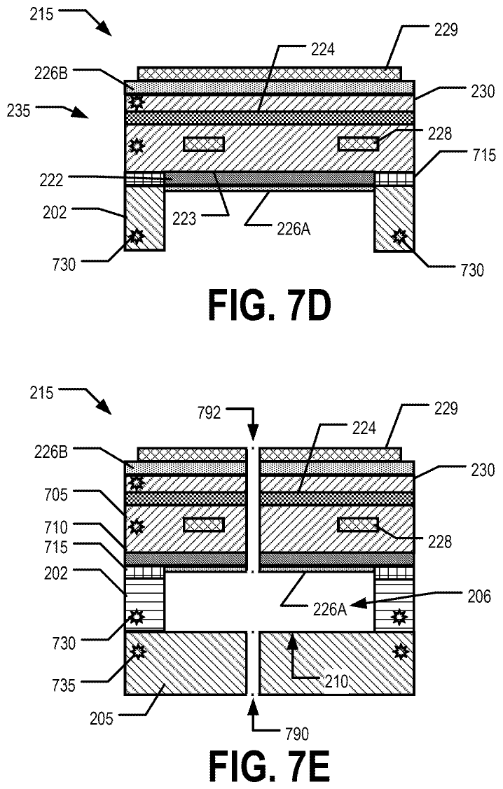

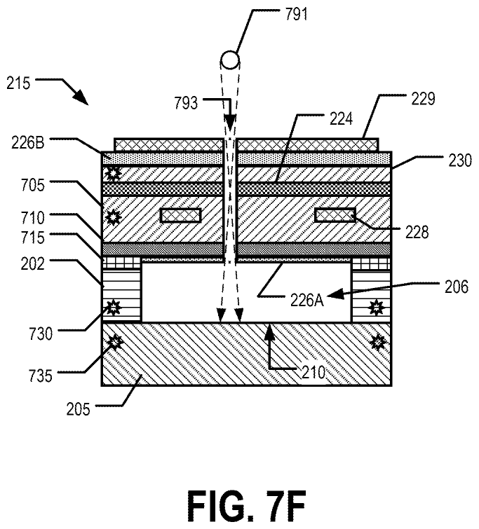

In various embodiments, the composite confinement assembly 200 includes a loading opening 790 and/or a particle flux opening 792, as shown in FIG. 7E. For example, the confinement apparatus 210 may be configured to receive a flux of quantum objects via the loading opening 790. In various embodiments, the loading opening 790 is a through hole through the confinement apparatus substrate 205. In various embodiments, the particle flux opening 792 is configured to enable quantum objects that are not captured and/or confined by the confinement apparatus 210 to escape and/or exit the confinement apparatus volume 206. In an example embodiment, the particle flux opening 792 and the loading opening 790 define respective opening axis that are aligned (e.g., co-linear) with one another. In various embodiments, the particle flux opening 792 is a through hole through the photonic platform 215, or possibly the confinement apparatus substrate 205.

In various embodiments, the composite confinement assembly 200 includes a loading opening 793 in the photonic platform 215, as shown in FIG. 7F. In various embodiments, the confinement apparatus 210 may be configured to receive quantum objects produced by a quantum object source 791 via the loading opening 793 in the photonic platform 215. The loading opening 793 may be a through hole through the photonic platform 215. In various embodiments, the photonic platform 215 may also include a particle flux opening (for example a particle flux opening 792 as shown in FIG. 7E) configured to enable quantum objects that are not captured and/or confined by the confinement apparatus 210 to escape and/or exit the confinement apparatus volume 206.

In various embodiments, the confinement apparatus substrate 205 may also include a particle flux opening configured to enable quantum objects that are not captured and/or confined by the confinement apparatus 210 to escape and/or exit the confinement apparatus volume 206. In various embodiments, the particle flux opening may be a through hole in the photonic platform 215 (for example a particle flux opening 792 in the as shown in FIG. 7E). For example, the particle flux opening may be a through hole in parallel with the loading opening 793. In another example, the particle flux opening may not be in parallel with the loading opening. In various embodiments, the particle flux opening may be a through hole in the confinement apparatus substrate 205. In an example embodiment, the particle flux opening and the loading opening define respective opening axis that are aligned (e.g., co-linear) with one another.

Referring now to FIG. 7F a schematic diagram illustrating a composite confinement apparatus assembly is provided in accordance with various embodiments of the present disclosure. The composite confinement apparatus assembly may include a quantum object confinement apparatus 210 fabricated on a confinement apparatus substrate 205. The composite confinement apparatus assembly may include a photonic platform 215. The photonic platform 215 may include one or more photonic components hosted by a photonic platform substrate (for example photonic platform substrate 220 with reference to FIG. 2). The photonic platform 215 may include a loading opening 793. The loading opening 793 may be configured to pass quantum objects to the quantum object confinement apparatus 210.

In various embodiments, the photonic platform substrate 220 is mechanically coupled to the confinement apparatus substrate 205 to form the composite confinement apparatus assembly. In various embodiments, the quantum objects are generated by a source 791 outside the composite confinement apparatus assembly and pass through the loading opening 793 to the quantum object confinement apparatus 210 (as for example shown by the dashed arrows from the source 791 to the confinement apparats assembly 210 in FIG. 7F).

In various embodiments, the loading opening comprises a through hole through the photonic platform. The photonic platform may include one or more photonic layers (for example various layers of the photonic platform 215 shown in FIG. 7F) and the loading opening may pass through one or all the photonic layers.

In various embodiments, the composite confinement apparatus assembly comprises a confinement apparatus volume 206 created by mechanically coupling the photonic platform substrate with the confinement apparatus substrate.

In various embodiments, the composite confinement apparatus assembly includes a particle flux opening configured to pass quantum objects that are not captured and/or confined by the confinement apparatus to exit the confinement apparatus volume.

In various embodiments, the particle flux opening may include a through hole through the photonic platform (for example flux opening 792 with reference to FIG. 7E). In various embodiments, the particle flux opening is parallel with the loading opening. In various embodiments, the particle flux opening is not parallel with the loading opening.

In various embodiments, the particle flux opening includes a through hole through the confinement apparatus. In various embodiments, the particle flux opening may be co-linear with the loading opening. In various embodiments, the particle flux opening may be non-co-linear with the loading opening.

### Example Method for Fabricating a Composite Confinement Apparatus Assembly

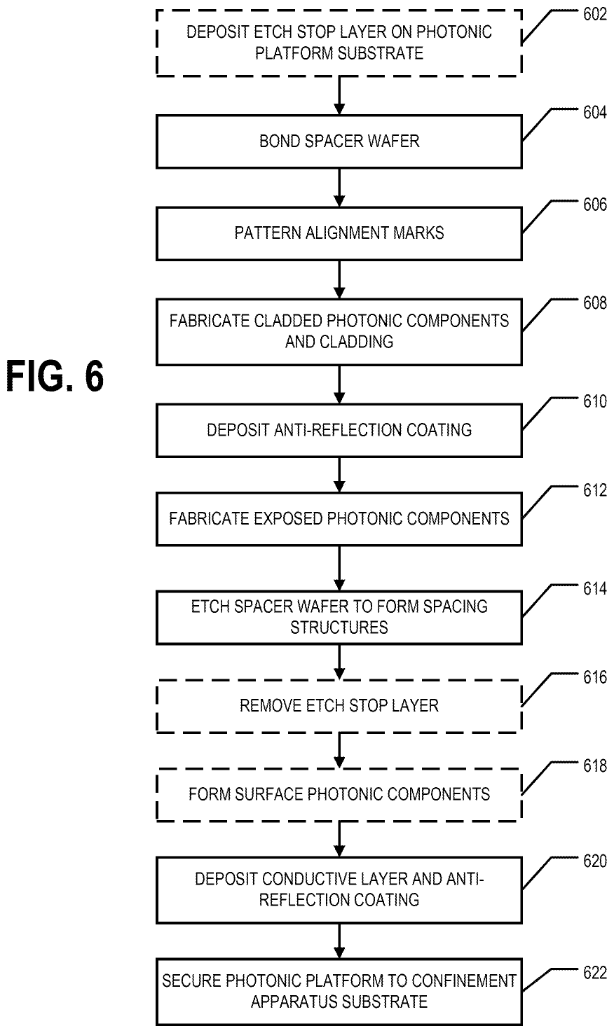

FIG. 6 provides a flowchart illustrating an example method for fabricating a composite confinement apparatus assembly 200, according to an example embodiment. Starting at step 602, in an example embodiment, an etch stop layer is deposited on a surface of a photonic platform substrate. For example, a photonic substrate may be provided and etch stop material may be deposited on a surface thereof to form an etch stop layer. In an example embodiment, the etch stop layer is deposited on an un-patterned photonic platform substrate (e.g., a photonic platform substrate that does not yet have photonic components formed thereon or in). In an example embodiment, one or more photonic platform substrates are formed on and/or in the photonic platform substrate prior to the etch stop layer being deposited thereon.

At step 604, a spacer wafer is bonded to the photonic platform substrate. For example, the spacer wafer may be bonded to the photonic platform substrate such that the etch stop layer is disposed between the spacer wafer and the photonic platform substrate. For example, the spacer wafer may be a silicon (Si) handle or other handle substrate that is bonded to the photonic platform substrate which comprises a translucent material with respect to light of the particular wavelength range. In example embodiments the spacer wafer may comprise silicon dioxide, silicon nitride, aluminum oxide, aluminum nitride, tantalum pentoxide, hafnia, or silicon carbide. For example, the material for the spacer wafer and the photonic platform substrate may be selected such that the both the photonic platform and the spacer are optically transparent.

In an example embodiment, the thickness of the spacer wafer in a direction perpendicular to the surface of the spacer wafer that is bonded to the photonic platform substrate corresponds to a desired set distance h between the photonic platform 215 and the confinement apparatus substrate 205. For example, the thickness of the spacer wafer and any present etch stop layer are equal to the desired set distance h, in an example embodiment. In another example embodiment, the spacer wafer is thinned after the spacer wafer is bonded to the photonic platform substrate such that the thickness of the spacer wafer and any present etch stop layer are equal to the desired set distance h, in an example embodiment.

FIG. 7A illustrates an example of an un-patterned photonic platform substrate 705 having an etch stop layer 715 deposited thereon, and a spacer wafer 720 bonded thereto such that etch stop layer 715 is disposed between the un-patterned photonic platform substrate 705 and the spacer wafer 720.

Continuing with FIG. 6, at step 606, alignment marks are patterned onto the un-patterned photonic platform substrate 705 and/or the spacer wafer 720. In an example embodiment, the alignment marks are patterned using a lithographic, masked, or other placement controlled deposition and/or patterning of one or more surfaces of the photonic platform substrate 705 and/or the spacer wafer 720.

At step 608, one or more cladded photonic components 228 are fabricated on and/or in the photonic platform substrate 705. One or more cladding layers 230 may be deposited. For example, one or more cladded photonic components 228 may be fabricated on an exposed surface of the photonic platform substrate 705. One or more cladding layers 230 may then be deposited thereon to clad the cladded photonic components 228 (e.g., to embed the photonic components within the cladding). In various embodiments, the cladded photonic components 228 may include waveguides and/or waveguide layers 224 in addition to optical sinks, reflective and/or diffractive optics, metasurfaces, and/or the like. In an example embodiment, the fabrication of photonic components and cladding layers may be alternated so as to fabricate a photonic platform 215 comprising a plurality of layers of cladded photonic components 228. In various embodiments, a smoothing or polishing step (e.g., mechanical and/or chemical polishing) may be performed after the deposition of each cladding layer.

FIG. 7B illustrates a result of performing step 608, where the photonic platform substrate 705, has cladded photonic components 228, including waveguide layer 224, and cladding layers 230 formed thereon. For example, cladded photonic components 228 (including waveguide layer 224) and cladding layers 230 have been formed on the un-patterned photonic platform substrate 705 to fabricate a component-integrated platform substrate 235. Alignment marks 730 have been patterned onto the component-integrated platform substrate 235.

Continuing with FIG. 6, at step 610, an anti-reflection coating 226B is deposited and/or applied to a first surface 225 of the component-integrated platform substrate 235. For example, the anti-reflection coating 226B may be applied, formed, and/or deposited on the first surface 225 of the component-integrated platform substrate 235. In various embodiments, the anti-reflection coating 226B is engineered to minimize and/or reduce the reflection of light off of the first surface 225. For example, the anti-reflection coating 226B is configured, engineered, and/or designed, to increase and/or maximize the transmission coefficient across the first surface 225. In various embodiments, the first surface 225 of the component-integrated platform substrate 235 is configured to face away from the confinement apparatus substrate 205.

At step 612, exposed photonic components 229 are fabricated on the anti-reflection coating 226B. For example, one or more exposed photonic components 229 may be fabricated, formed, and/or mounted to the anti-reflection coating 226B and/or first surface 225 of the component-integrated platform substrate 235. In various embodiments, the exposed photonic component(s) 229 include one or more metasurfaces, a metasurface array, one or more lenses, a lenslet array, and/or the like. In an example embodiment, the exposed photonic component 229 is configured to couple manipulation signals into the photonic platform 215 (e.g., direct the manipulation signals to respect cladded photonic components 228). In an example embodiment, one or more of the exposed photonic components 229 are configured to collimate light emitted by a quantum object disposed at a respective object location and/or otherwise direct the light emitted by a quantum object toward a collection system 430.

FIG. 7C illustrates the result of depositing and/or applying the anti-reflection coating 226B to the component-integrated platform substrate 235 and fabricating the exposed photonic component(s) 229 thereon.

Returning to FIG. 6, at step 614, the spacer wafer 720 is etched to form spacing structures 202. For example, a portion of the spacer wafer 720 is etched to the etch stop layer 715 (if present) or the second surface 223 in the photonic platform substrate 220. In various embodiments, the etching is performed as appropriate for the material of the spacer wafer 720. For example, the spacer wafer 720 is etched away so what remains of the spacer wafer is the spacing structures 202.

At step 616, in an example embodiment, the etch stop layer 715 is removed. For example, if an etch stop layer 715 is present, the etch stop layer be removed to expose the second surface 223 of the photonic platform substrate 220 and/or component-integrated platform substrate 235.

At step 618, in an example embodiment, one or more surface photonic components (e.g., 812, 822, 832, 842, 852) are formed on the second surface 223 of the photonic platform substrate 220 and/or component-integrated platform substrate 235. In an example embodiment, the one or more surface photonic components are formed through appropriate depositing and/or etching steps. For example, for surface photonic components that extend out from the second surface 223, material is deposited on the second surface and then patterned to form and/or shape the desired surface photonic component reflective surface(s) (e.g., 814, 834, 844, 854). In another example, for the surface photonic components that are recessed in the second surface, a corresponding portion of the second surface is patterned, etched, and/or shaped to from the desired surface photonic component reflective surface(s) (e.g., 824).

In an example embodiment, a reflective coating is applied to the surface photonic component reflective surface(s) 814, 824, 834, 844, 854). In an example embodiment, the one or more photonic surface photonic components are formed after deposition of the conductive layer 222 on the second surface 223 and/or after deposition of the anti-reflection coating 226A on the confinement apparatus-facing surface 221 of the conductive layer 222. In an example embodiment, the anti-reflection coating 226A and/or conductive layer 222 is removed at the location where the photonic surface component is to be formed and the photonic surface component is then formed in the location where the anti-reflection coating 226A and/or conductive layer 222 was removed.

At step 620, a conductive layer 222 is deposited on the second surface 223 of the photonic platform substrate 220 and/or component-integrated platform substrate 235. For example, the conductive layer is electrically conductive and is either transparent to light characterized by wavelengths within the particular wavelength range or comprises electrically conductive windows that are transparent to light characterized by wavelengths within the particular wavelength range. In an example embodiment, the conductive layer 222 is deposited on the second surface 223 of the photonic platform substrate 220 and/or component-integrated platform substrate 235 and one or more surfaces of the spacing structures 202. For example, in an example embodiment, the surfaces of the spacing structures that face the space that will be the confinement apparatus volume 206 may have a conductive layer 222 deposited thereon. In various embodiments, the conductive layer 222 is configured to be grounded and/or held at a fixed electric potential.

In an example embodiment, the conductive layer 222 has anti-reflective properties. In an example embodiment, an anti-reflection coating 226A is deposited and/or applied to the confinement apparatus-facing surface 221. For example, the anti-reflection coating 226A may be applied, formed, and/or deposited on the confinement apparatus-facing surface 221 of the conductive layer 222 and/or component-integrated platform substrate 235. In various embodiments, the anti-reflection coating 226A is engineered to minimize and/or reduce the reflection of light off of the confinement apparatus-facing surface 221. For example, the anti-reflection coating 226A is configured, engineered, and/or designed, to increase and/or maximize the transmission coefficient across the confinement apparatus-facing surface 221. In various embodiments, the confinement apparatus-facing surface 221 of the conductive layer 222 and/or component-integrated platform substrate 235 is configured to face toward the confinement apparatus substrate 205. In an example embodiment, anti-reflection coating 226A is also deposited on one or more surfaces of the spacing structures 202 (e.g., the surfaces of the spacing structures that face in toward what will be the confinement apparatus volume 206).

In an example embodiment, the anti-reflection coating 226A is either not deposited (e.g., using a masking process) and/or removed from the locations where the reflective surfaces 514, 524, 534, 544, 554 are or will be located.

FIG. 7D illustrates a photonic platform 215. For example, FIG. 7D illustrates the result of performing step 620. A shown in FIG. 7D, the photonic platform 215 comprises a component-integrated platform substrate 235 that includes a photonic platform substrate 220, cladding layers 230, and cladded photonic components 228, including waveguide layer 224. The photonic platform 215 includes an anti-reflection coating 226B on the first surface 225 of the component-integrated platform substrate 235 and an exposed photonic component 229 formed thereon. The photonic platform 215 further includes the conductive layer 222 formed on a second surface of the component-integrated platform substrate 235 and an anti-reflection coating 226A applied to a confinement apparatus-facing surface 221 thereof. The photonic platform 215 has a plurality of spacing structures 202 mechanically secured thereto. The photonic platform 215 and/or spacing structures 202 have alignment marks 730 disposed and/or patterned thereon.

Before, during, or after the fabricating of the photonic platform 215, a confinement apparatus 210 is formed on a confinement apparatus substrate 205. In various embodiments, one or more optical components 214 are formed on and/or in the confinement apparatus substrate 205. In various embodiments, alignment marks 735 are formed and/or patterned on the confinement apparatus substrate 205, as shown in FIG. 7E. In various embodiments, the alignment marks 735 formed and/or patterned on the confinement apparatus substrate 205 correspond to the alignment marks 730 formed and/or patterned on the spacing structures 202 and/or photonic platform 215. For example, the alignment marks 735 indicate the location of respective bond locations on the confinement apparatus substrate to which the spacing structures 202 are to be secured, bonded, and/or coupled.

At step 622, the photonic platform 215 is secured to the confinement apparatus substrate 205 to form a composite confinement apparatus assembly 200. For example, alignment marks 730 on the photonic platform 215 and/or spacing structures 202 are aligned with corresponding alignment marks 735 on the confinement apparatus substrate 205. The spacing structures 202 are then bonded and/or mechanically coupled to the confinement apparatus substrate 205 with the alignment marks 735 in alignment with respective corresponding alignment marks 730.

### Technical Advantages

Conventionally, laser beams are provided to positions within an ion trap through the use of external lasers and free space optics configured to provide the laser beams to specific positions within the ion trap. However, the amount of space required for such beam paths, even to provide laser beams to a relatively small number of defined positions of the ion trap, is significant (e.g., a few square meters). Additionally, the accuracy with which the laser beams may be provided to the positions within the ion trap through such conventional means can limit the density of the defined positions of ion trap. Moreover, ion traps are generally utilized within a cryogenic and/or vacuum chamber. As such, the laser beams must be passed through the cryogenic and/or vacuum chamber and any radiation and/or thermal shields therein. Thus, a technical problem exists as to how to provide manipulation signals to a quantum object confinement apparatus that is able to scale with the size and/or dimensions of the quantum object confinement apparatus efficiently and accurately. These technical problems are compounded as the quantum object confinement apparatus is increased in size (e.g., as the number of positions or object locations defined for the quantum object confinement apparatus increases).

Various embodiments provide technical solutions to these technical problems. In particular, in various embodiments, optical elements of the signal management system are incorporated and/or integrated into a composite confinement apparatus assembly. For example, one or more optical elements of the signal management system are disposed within the cryogenic and/or vacuum chamber. For example, the one or more optical elements of the signal management system include photonic components that are part of a photonic platform that is coupled and/or secured into relation with the confinement apparatus and/or confinement apparatus substrate. In some embodiments, the one or more optical elements of the signal management system include optical components disposed on the confinement apparatus substrate. These one or more optical elements include passive and/or active optical elements configured to control various parameters of respective manipulation signals and accurately direct respective manipulation signals to respective object locations. In various embodiments, the one or more optical elements include active optical elements include photodetectors such as photodiode, photomultiplier, charge-coupled device (CCD) sensor, complementary metal oxide semiconductor (CMOS) sensor, Micro-Electro-Mechanical Systems (MEMS) sensor, modulator, and/or other photodetectors. In various embodiments, the use of the photonics platform reduces the spatial requirements for free space optics beam path configurations, number of cryogenic and/or vacuum chamber pass throughs, and/or the like. Furthermore, the configuration of the composite confinement apparatus assembly of various embodiments reduces the additional technical problems of signal management systems of larger confinement apparatuses. For example, the photonics platform is scalable with the confinement apparatus such that the signal management system is configurable for accommodating various numbers and/or arrangements/layouts of object locations. Thus, various embodiments provide technical solutions to technical problems regarding how to provide manipulation signals to an array of object locations defined at least in part by a confinement apparatus such that the manipulation signals are efficiently and effectively provided to the object locations, even when the object locations form a two or three-dimensional array.

### Exemplary Controller

In various embodiments, a composite confinement apparatus assembly 200 is incorporated into a system (e.g., a quantum computer 110) comprising a controller 30. In various embodiments, the controller 30 is configured to control various elements of the system (e.g., quantum computer 110). For example, the controller 30 may be configured to control the voltage sources 50, a cryogenic system and/or vacuum system controlling the temperature and pressure within the cryogenic and/or vacuum chamber 40, manipulation sources 300, cooling system, and/or other systems controlling the environmental conditions (e.g., temperature, humidity, pressure, and/or the like) within the cryogenic and/or vacuum chamber 40 and/or configured to manipulate and/or cause a controlled evolution of quantum states of one or more quantum objects confined by the confinement apparatus 210 of the composite confinement apparatus assembly 200. In various embodiments, the controller 30 may be configured to receive signals from one or more photodetectors (e.g., of a collection system 430 and/or the like), calibration sensors, and/or the like.

As shown in FIG. 8, in various embodiments, the controller 30 may comprise various controller elements including processing elements 805, memory 810, driver controller elements 815, a communication interface 820, analog-digital (A/D) converter elements 825, and/or the like. For example, the processing elements 805 may comprise programmable logic devices (CPLDs), microprocessors, coprocessing entities, application-specific instruction-set processors (ASIPs), integrated circuits, application specific integrated circuits (ASICs), field programmable gate arrays (FPGAs), programmable logic arrays (PLAs), hardware accelerators, other processing devices and/or circuitry, and/or the like. and/or controllers. The term circuitry may refer to an entirely hardware embodiment or a combination of hardware and computer program products. In an example embodiment, the processing element 805 of the controller 30 comprises a clock and/or is in communication with a clock.

For example, the memory 810 may comprise non-transitory memory such as volatile and/or non-volatile memory storage such as one or more of as hard disks, ROM, PROM, EPROM, EEPROM, flash memory, MMCs, SD memory cards, Memory Sticks, CBRAM, PRAM, FeRAM, RRAM, SONOS, racetrack memory, RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. In various embodiments, the memory 810 may store a queue of commands to be executed to cause a quantum algorithm and/or circuit to be executed (e.g., an executable queue), qubit records corresponding the qubits of quantum computer (e.g., in a qubit record data store, qubit record database, qubit record table, and/or the like), a calibration table, computer program code (e.g., in a one or more computer languages, specialized controller language(s), and/or the like), and/or the like. In an example embodiment, execution of at least a portion of the computer program code stored in the memory 810 (e.g., by a processing element 805) causes the controller 30 to perform one or more steps, operations, processes, procedures and/or the like described herein for providing manipulation signals to quantum object positions and/or collecting, detecting, capturing, and/or measuring indications of emitted signals emitted by quantum objects located at corresponding object locations 5 of the composite confinement apparatus assembly 200.

In various embodiments, the driver controller elements 815 may include one or more drivers and/or controller elements each configured to control one or more drivers. In various embodiments, the driver controller elements 815 may comprise drivers and/or driver controllers. For example, the driver controllers may be configured to cause one or more corresponding drivers to be operated in accordance with executable instructions, commands, and/or the like scheduled and executed by the controller 30 (e.g., by the processing element 805). In various embodiments, the driver controller elements 815 may enable the controller 30 to operate a voltage sources 50, manipulation sources 300, cooling system, and/or the like. In various embodiments, the drivers may be laser drivers configured to operate one or manipulation sources 300 to generate manipulation signals; vacuum component drivers; drivers for controlling the flow of current and/or voltage applied to electrodes used for maintaining and/or controlling the trapping potential of the composite confinement apparatus assembly 200 (and/or other drivers for providing driver action sequences to potential generating elements of the optics-integrated confinement apparatus); cryogenic and/or vacuum system component drivers; cooling system drivers, and/or the like. In various embodiments, the controller 30 comprises means for communicating and/or receiving signals from one or more optical receiver components (e.g., photodetectors or collection system 430). For example, the controller 30 may comprise one or more analog-digital converter elements 825 configured to receive signals from one or more optical receiver components (e.g., a photodetector of the optics collection system), calibration sensors, and/or the like.

In various embodiments, the controller 30 may comprise a communication interface 820 for interfacing and/or communicating with a computing entity 10. For example, the controller 30 may comprise a communication interface 820 for receiving executable instructions, command sets, and/or the like from the computing entity 10 and providing output received from the quantum computer 110 (e.g., from an optical collection system) and/or the result of a processing the output to the computing entity 10. In various embodiments, the computing entity 10 and the controller 30 may communicate via a direct wired and/or wireless connection and/or via one or more wired and/or wireless networks 20.

### Exemplary Computing Entity

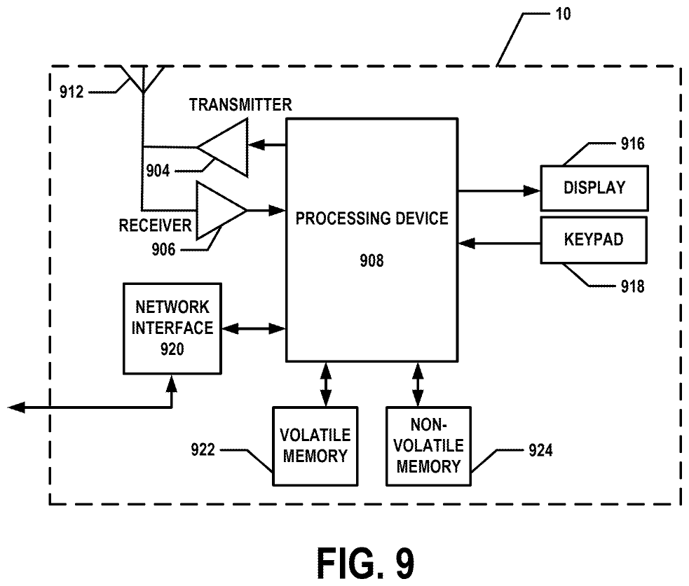

FIG. 9 provides an illustrative schematic representative of an example computing entity 10 that can be used in conjunction with embodiments of the present invention. In various embodiments, a computing entity 10 is configured to allow a user to provide input to the quantum computer 110 (e.g., via a user interface of the computing entity 10) and receive, display, analyze, and/or the like output from the quantum computer 110.

As shown in FIG. 9, a computing entity 10 can include an antenna 912, a transmitter 904 (e.g., radio), a receiver 906 (e.g., radio), and a processing element 908 that provides signals to and receives signals from the transmitter 904 and receiver 906, respectively. The signals provided to and received from the transmitter 904 and the receiver 906, respectively, may include signaling information/data in accordance with an air interface standard of applicable wireless systems to communicate with various entities, such as a controller 30, other computing entities 10, and/or the like. In this regard, the computing entity 10 may be capable of operating with one or more air interface standards, communication protocols, modulation types, and access types. For example, the computing entity 10 may be configured to receive and/or provide communications using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the computing entity 10 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol. The computing entity 10 may use such protocols and standards to communicate using Border Gateway Protocol (BGP), Dynamic Host Configuration Protocol (DHCP), Domain Name System (DNS), File Transfer Protocol (FTP), Hypertext Transfer Protocol (HTTP), HTTP over TLS/SSL/Secure, Internet Message Access Protocol (IMAP), Network Time Protocol (NTP), Simple Mail Transfer Protocol (SMTP), Telnet, Transport Layer Security (TLS), Secure Sockets Layer (SSL), Internet Protocol (IP), Transmission Control Protocol (TCP), User Datagram Protocol (UDP), Datagram Congestion Control Protocol (DCCP), Stream Control Transmission Protocol (SCTP), HyperText Markup Language (HTML), and/or the like.

Via these communication standards and protocols, the computing entity 10 can communicate with various other entities using concepts such as Unstructured Supplementary Service information/data (USSD), Short Message Service (SMS), Multimedia Messaging Service (MMS), Dual-Tone Multi-Frequency Signaling (DTMF), and/or Subscriber Identity Module Dialer (SIM dialer). The computing entity 10 can also download changes, add-ons, and updates, for instance, to its firmware, software (e.g., including executable instructions, applications, program modules), and operating system.

In various embodiments, the computing entity 10 may comprise a network interface 920 for interfacing and/or communicating with the controller 30, for example. For example, the computing entity 10 may comprise a network interface 920 for providing executable instructions, command sets, and/or the like for receipt by the controller 30 and/or receiving output and/or the result of a processing the output provided by the quantum computer 110. In various embodiments, the computing entity 10 and the controller 30 may communicate via a direct wired and/or wireless connection and/or via one or more wired and/or wireless networks 20.

The computing entity 10 may also comprise a user interface device comprising one or more user input/output interfaces (e.g., a display 916 and/or speaker/speaker driver coupled to a processing element 908 and a touch screen, keyboard, mouse, and/or microphone coupled to a processing element 908). For instance, the user output interface may be configured to provide an application, browser, user interface, interface, dashboard, screen, webpage, page, and/or similar words used herein interchangeably executing on and/or accessible via the computing entity 10 to cause display or audible presentation of information/data and for interaction therewith via one or more user input interfaces. The user input interface can comprise any of a number of devices allowing the computing entity 10 to receive data, such as a keypad 918 (hard or soft), a touch display, voice/speech or motion interfaces, scanners, readers, or other input device. In embodiments including a keypad 918, the keypad 918 can include (or cause display of) the conventional numeric (0-9) and related keys (#, *), and other keys used for operating the computing entity 10 and may include a full set of alphabetic keys or set of keys that may be activated to provide a full set of alphanumeric keys. In addition to providing input, the user input interface can be used, for example, to activate or deactivate certain functions, such as screen savers and/or sleep modes. Through such inputs the computing entity 10 can collect information/data, user interaction/input, and/or the like.

The computing entity 10 can also include volatile storage or memory 922 and/or non-volatile storage or memory 924, which can be embedded and/or may be removable. For instance, the non-volatile memory may be ROM, PROM, EPROM, EEPROM, flash memory, MMCs, SD memory cards, Memory Sticks, CBRAM, PRAM, FeRAM, RRAM, SONOS, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. The volatile and non-volatile storage or memory can store databases, database instances, database management system entities, data, applications, programs, program modules, scripts, source code, object code, byte code, compiled code, interpreted code, machine code, executable instructions, and/or the like to implement the functions of the computing entity 10.

### CONCLUSION

Many modifications and other embodiments of the invention set forth herein will come to mind to one skilled in the art to which the invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. A composite confinement apparatus assembly comprising:
a quantum object confinement apparatus comprising one or more electrical components, wherein the quantum object confinement apparatus is fabricated on a confinement apparatus substrate; and
a photonic platform comprising one or more photonic components hosted by a photonic platform substrate, wherein the photonic platform substrate is mechanically coupled to the confinement apparatus substrate to form the composite confinement apparatus assembly.

2. The composite confinement apparatus assembly of claim 1, wherein the photonic platform comprises a conductive layer confinement apparatus substrate on a surface of the photonic platform substrate facing the quantum object confinement apparatus, wherein the conductive layer comprises a transparent section of the conductive layer and at least one of (a) the conductive layer is configured to be held at a fixed electric potential or (b) the conductive layer comprises a plurality of patterned electrodes.

3. The composite confinement apparatus assembly of claim 2, wherein at least one of (a) a surface of the conductive layer facing the quantum object confinement apparatus has an anti-reflecting property, or (b) the photonic platform comprises an anti-reflective layer on a surface of the photonic platform substrate facing away from the quantum object confinement apparatus.

4. The composite confinement apparatus assembly of claim 2, wherein the photonic platform comprises one or more photonic platform sink components configured to act as a respective optical sink configured to facilitate removal of one or more undesired photons from a space between the quantum object confinement apparatus and the photonic platform for reducing an undesired illumination of one or more untargeted quantum objects located between the quantum object confinement apparatus and the photonic platform.

5. The composite confinement apparatus assembly of claim 4, wherein the one or more sink components comprise one or more of a hole in the photonic platform configured to pass at least a first portion of the one or more undesired photons through the photonic platform substrate, an engineered coating with high optical transmittance configured to transmit at least a second portion of the one or more undesired photons therethrough, and a photon absorber configured to absorb at least a third portion of the one or more undesired photons.

6. The composite confinement apparatus assembly of claim 1, wherein the one or more photonic components of the photonic platform comprise:
one or more flat optics elements;
one or more guided mode photonic elements;
one or more microfabricated lenses;
one or more claddings;
one or more photonic filters;
one or more photonic convertors;
one or more photonic detectors; or
one or more active optical elements.

7. The composite confinement apparatus assembly of claim 1, wherein the quantum object confinement apparatus comprises a confinement apparatus photon sink configured to facilitate removal of one or more undesired photons from a space between the quantum object confinement apparatus and the photonic platform for reducing an undesired illumination of one or more untargeted quantum objects located in the space between the quantum object confinement apparatus and the photonic platform, wherein the confinement apparatus photon sink comprises one or more of a hole or transparent window in the confinement apparatus substrate configured to pass at least a first portion of the one or more undesired photons through the confinement apparatus substrate, and a photon absorber configured to absorb at least a second portion of the one or more undesired photons.

8. The composite confinement apparatus assembly of claim 7, wherein the hole or transparent window in the photonic platform substrate configured to pass at least the first portion of the one or more undesired photons through the confinement apparatus substrate is further configured to dissipate at least the first portion of the one or more undesired photons.

9. The composite confinement apparatus assembly of claim 7, wherein the hole in the quantum object confinement apparatus comprises a sink photon absorber configured to absorb at least the first portion of the one or more undesired photons in the hole in the confinement apparatus substrate.

10. The composite confinement apparatus assembly of claim 1, wherein an optical component is formed on the confinement apparatus substrate, the optical component configured to be illuminated by a first optical beam or pulse train and provide a second optical beam or pulse train toward a defined location, wherein the defined location is defined at least in part by the confinement apparatus.

11. The composite confinement apparatus assembly of claim 10, wherein the photonic platform is configured to at least one of (a) provide the first optical beam or pulse train to the optical component or (b) provide a third optical beam or pulse train to the defined location, wherein the third optical beam or pulse train is co-axial to the second optical beam or pulse train.

12. The composite confinement apparatus assembly of claim 1, wherein the photonic platform substrate is mechanically coupled to the confinement apparatus substrate via one or more spacing structures.

13. The composite confinement apparatus assembly of claim 12, wherein each of the one or more spacing structures has a thickness corresponding to a set distance between the photonic platform and the confinement apparatus substrate.

14. The composite confinement apparatus assembly of claim 12, wherein at least one of the one or more spacing structures comprises respective actuators configured to mechanically couple the photonic platform to the confinement apparatus substrate in an adjustable manner.

15. The composite confinement apparatus assembly of claim 14, wherein the respective actuators comprise a piezoelectric actuator.

16. The composite confinement apparatus assembly of claim 1, wherein the photonic platform substrate is mechanically coupled to the confinement apparatus substrate via a nano-positioner mounting apparatus.

17. A method for fabricating a composite confinement apparatus assembly, the method comprising:
fabricating a photonic platform comprising one or more photonic components hosted by a photonic platform substrate, the photonic platform substrate having one or more spacing structures extending from a confinement apparatus-facing surface of the photonic platform; and
coupling the one or more spacing structures to a confinement apparatus substrate, the confinement apparatus substrate having a quantum object confinement apparatus comprising one or more electrical components formed thereon.

18. The method of claim 17, further comprising:
bonding a spacer wafer to the photonic platform substrate; and
etching the spacer wafer to form the one or more spacing structures.

19. The method of claim 17, wherein the photonic platform substrate comprises a transparent material.

20. The method of claim 17, wherein the photonic platform substrate comprises silicon dioxide, silicon nitride, aluminum oxide, aluminum nitride, tantalum pentoxide, hafnia, or silicon carbide, and the spacer wafer comprises silicon, silicon dioxide, silicon nitride, aluminum oxide, aluminum nitride, tantalum pentoxide, hafnia, or silicon carbide.

21. The method of claim 17, wherein fabricating the photonic platform comprises fabricating one or more photonic components on and/or in the photonic platform substrate.

22. The method of claim 21 wherein the one or more photonic components comprise one or more of:
one or more flat optics elements;
one or more guided mode photonic elements;
one or more microfabricated lenses;
one or more claddings;
one or more photonic filters;
one or more photonic convertors;
one or more photonic detectors; or
one or more active optical elements.

23. The method of claim 17, wherein fabricating the photonic platform comprises:
fabricating one or more first photonic components on a surface of the photonic platform substrate configured to face away from the confinement apparatus;
fabricating a cladding layer on the one or more first photonic components;
smoothing a surface of the cladding layer; and
fabricating one or more second photonic components on the smoothed cladding.

24. The method of claim 23, wherein an anti-reflection coating is applied to the surface of the smoothed cladding.

25. The method of claim 23, wherein the cladding layer and the photonic platform substrate comprise a common transparent material.

26. The method of claim 17, wherein fabricating the photonic platform comprises fabricating a conductive layer on a surface of the photonic platform substrate configured to face the confinement apparatus.

27. The method of claim 26, wherein a surface of the conductive layer configured to face the quantum object confinement apparatus has anti-reflective properties.

28. The method of claim 17, wherein relative positions of the one or more spacing structures are defined using lithography.

29. The method of claim 17, further comprising:
patterning one or more alignment marks on each of the one or more spacing structures; and
patterning corresponding alignment marks to each of one or more bond locations on the confinement apparatus substrate;
wherein coupling the one or more spacing structures to a confinement apparatus substrate comprises aligning the one or more alignment marks with the corresponding alignment marks and bonding the one or more spacing structures to the bond locations on the confinement apparatus substrate.

30. The method of claim 17, wherein the one or more spacing structures comprise respective actuators configured to adjust a relative positioning of the photonic platform and the confinement apparatus with respect to each other.

31. The method of claim 30, wherein the respective nano-positioners comprise respective piezoelectric actuators.

32. A quantum processor comprising:
a cryogenic and/or vacuum chamber; and
a composite confinement apparatus assembly of claim 1 disposed within the cryogenic and/or vacuum chamber.

33. A quantum computer comprising:
the quantum processor of claim 32; and
a controller configured to control at least one of voltage sources configured to provide voltage signal to the electrical components of the quantum object confinement apparatus or operation of a photonic component of the photonic platform that comprises an active optical element.

34. A composite confinement apparatus assembly comprising:
a quantum object confinement apparatus fabricated on a confinement apparatus substrate; and
a photonic platform comprising:
one or more photonic components hosted by a photonic platform substrate; and
a loading opening configured to pass quantum objects to the quantum object confinement apparatus,
wherein the photonic platform substrate is mechanically coupled to the confinement apparatus substrate to form the composite confinement apparatus assembly, and the quantum objects are generated by a source outside the composite confinement apparatus assembly.

35. The composite confinement apparatus assembly of claim 34, wherein the loading opening comprises a through hole through the photonic platform.

36. The composite confinement apparatus assembly of claim 35, wherein the photonic platform comprises one or more photonic layers and the loading opening passes through all the photonic layers.

37. The composite confinement apparatus assembly of claim 34 comprising a confinement apparatus volume created by mechanically coupling the photonic platform substrate with the confinement apparatus substrate.

38. The composite confinement apparatus assembly of claim 37 comprising a particle flux opening configured to pass quantum objects not captured and/or confined by the confinement apparatus to exit the confinement apparatus volume.

39. The composite confinement apparatus assembly of claim 38, wherein the particle flux opening comprises a through hole through the photonic platform.

40. The composite confinement apparatus assembly of claim 39, wherein the particle flux opening is parallel with the loading opening.

41. The composite confinement apparatus assembly of claim 38, wherein the particle flux opening comprises a through hole through the confinement apparatus.

42. The composite confinement apparatus assembly of claim 41, wherein the particle flux opening is co-linear with the loading opening.

43. A confinement apparatus assembly comprising:
a confinement apparatus substrate;
a confinement apparatus comprising a plurality of electrical components fabricated on the confinement apparatus substrate; and
one or more optical sinks formed on or in the confinement apparatus substrate.

44. The confinement apparatus assembly of claim 43, wherein an optical sink of the one or more optical sinks is at least one of (a) an absorbing optical sink configured to absorb light incident thereon or (b) a hole at least partially through the confinement apparatus substrate configured for light to pass therethrough.
